(19) United States
(12) Patent Application Publication
(10) Pub. No.: US 2002/0107777 A1
(43) Pub. Date: Aug. 8, 2002

(54) System and method for auctioning goods seized or recovered by local, county, state, or federal law enforcement agencies

(76) Inventors: Thomas P. Lane, San Clemente, CA (US); Robert J. Venter, Laguna Niguel, CA (US)

Correspondence Address: Stanley J. Gradisar, GIBSON, DUNN & CRUTCHER LLP, Suite 4100, 1801 California Street, Denver, CO, 80202, US

(21) Appl. No.: 09/778,053

(22) Filed: Feb. 6, 2001

(51) Int. Cl. G06F 17/60; G06F 7/00; G06F 17/00

(52) U.S. Cl. 705/37; 707/104.1; 705/28

(57) ABSTRACT

A service provider enters into a contractual relationship with a law enforcement agency to be their exclusive agent for auctioning seized property over the Internet. The service provider establishes a secure area for receiving, processing, and handling the seized property from the law enforcement agency. Seized items are received in the secure area, photographed, inventoried, and entered into the service provider inventory database. Appraisers evaluate each seized item, set a price for each seized item, prepare each seized item for posting, and post each seized item for auction on an Internet auction web site. The seized items are then auctioned off on the Internet web site. The winning bids are processed and payment collected. Sold items are then staged for shipping, removed from the inventory database, and then shipped to each winning bidder.

### FIELD OF THE INVENTION

This invention relates to internet auctions, and more particularly, to the internet auctioning of goods seized or recovered by local, county, state, or federal law enforcement and other government agencies.

### BRIEF DESCRIPTION OF THE DRAWINGS

FIG. 1 shows a block flow diagram of the method of internet auctioning of goods and property seized or recovered by local, county, state, or federal law enforcement and other government agencies of the present invention.

FIGS. 2A-B show a block flow diagram of the method of receiving goods, inventorying them by entering data on each item into a secure site computer, and uploading the data in a batch file to a remote computer system having a computer software application with an inventory database in an embodiment of the present invention.

FIGS. 3A-B show a block flow diagram of the method of receiving goods and inventorying them by entering data on each item online in real time from a client computer using an Internet/Intranet web-based computer software application hosted at a server computer having an inventory database in an embodiment of the present invention.

FIG. 4 shows a block flow diagram of the put-away process of the present invention.

FIG. 5 shows a block flow diagram of handling item exceptions of the present invention.

FIG. 6 shows a block flow diagram of the item review process of the present invention.

FIG. 7 shows a block flow diagram of processing auction data from the online auction of the present invention.

FIG. 8 shows a block flow diagram of the process of creating a kit of the present invention.

FIGS. 9A-B show a block flow diagram of the payment collection process of the present invention.

FIG. 10 shows a block flow diagram of the certified check process of the present invention.

FIG. 11 shows a block flow diagram of the staging process of the present invention.

FIG. 12 shows a block flow diagram of the shipping process of the present invention.

FIG. 13 shows an embodiment of the system of internet auctioning of goods seized or recovered by local, county, state, or federal law enforcement and other government agencies of the present invention.

### DETAILED DESCRIPTION OF THE INVENTION

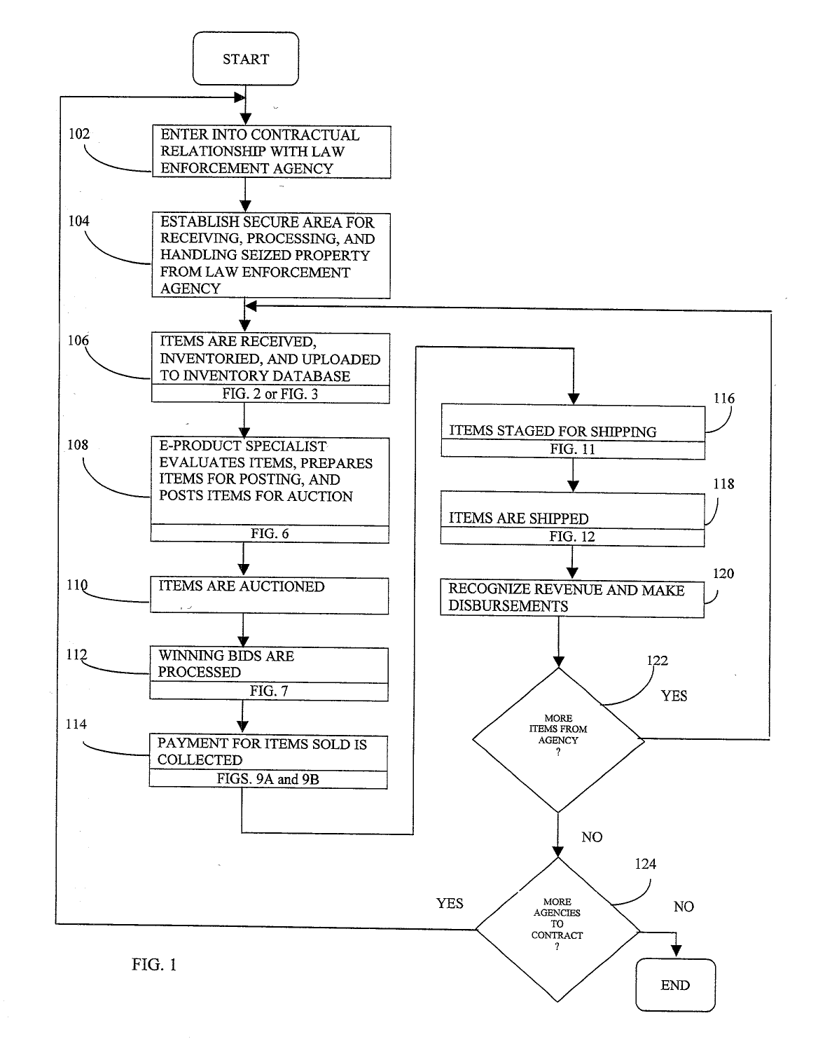

FIG. 1 shows a block flow diagram of the method of internet auctioning of goods and property seized or recovered by local, county, state, or federal law enforcement and other government agencies of the present invention. It is estimated that online consumer and business auction transactions will account for 29% of all e-commerce, roughly $129 billion, by the year 2002. The Internet's largest auction site, eBay, registered 1999 sales in excess of $2.7 billion. Online auctions so far in 2000 are running at a rate several times that of 1999. However, a certain segment of the auction business is not presently being served on the Internet. That segment involves property seized or recovered by local, county, state, and federal law enforcement and other government agencies that is auctioned off to the public every year. More than 18,000 police and sheriff departments, and fifteen federal agencies, recover or seize assets throughout the United States and subsequently dispose of those assets at auction. Police agencies currently receive pennies on the dollar for goods presently sold in local auctions. It is estimated that at fair prices the market value of goods recovered and seized by U.S. government and law enforcement agencies exceeds $6 billion annually.

Current practice is for each law enforcement agency to contract with a local auction house to auction off the seized goods on a regular basis by means of in-person, live auctions conducted most often at out-of-the-way and difficult to find local warehouses. Payment for successful bidders is by cash only, which creates an additional obstacle to obtaining good prices for the items sold. The advertising for such auctions is usually done solely through local papers and the ads usually run the week of the auction, which results in police and sheriffs' auctions drawing a small fraction of the buying public. The present invention provides a solution to these problems heretofore not met which provides a service to law enforcement and other government agencies and utilizes the Internet to auction off the seized goods.

Referring now to FIG. 1, the method of the present invention begins in step 102 by a service provider entering into a contractual relationship with a law enforcement or other government agency to be their exclusive agent for auctions over the Internet. The contractual relationship can be structured in many different ways. In a preferred embodiment of the invention, the service provider is not merely a commissioned agent, but has control over disposition of the seized goods inventory. The method of the present invention differentiates itself from other consumer-to-consumer Internet auction methods by controlling the agency's inventory and in all instances acting as the attorney in fact for the law enforcement or other government agency. The service provider enters into a revenue sharing agreement with the governmental agency and is thus not dependent upon fees from the agency to generate revenue. The service provider is free to merchandise the seized goods to attract the widest audience and return the highest value. Large shipments seized by law enforcement and other government agencies can be marketed to businesses that wholesale or retail those specific items. Smaller seizures are merchandised to sell via competitive bidding to individuals. Some truckload items may be broken out and merchandised as individual items if the market for that item will return a higher ultimate price if sold to individuals.

In step 104 a secure site is established for receiving, processing, and handling the seized property from the law enforcement or government agency. In one embodiment, the service provider stations its own employees in a secure site portion of the law enforcement agency space, such as a warehouse dedicated to seized property, to catalog, photograph, bar code, and uplink items offered for sale on an Internet web site.

In another embodiment, the service provider secures and maintains its own secure site, such as a private warehouse. Seized goods from one or more law enforcement or government agencies may be brought to the same service provider secure site for processing.

Where appropriate, qualified service provider employees, referred to as site personnel, verify that a seized item for sale is functional and/or shows no visible damage. The service provider then certifies the item as meeting specified standards, which adds considerably to the price many such items may command at auction. Once an item is sold, the service provider's site personnel handle the fulfillment and shipping of the items to the winning auction bidder.

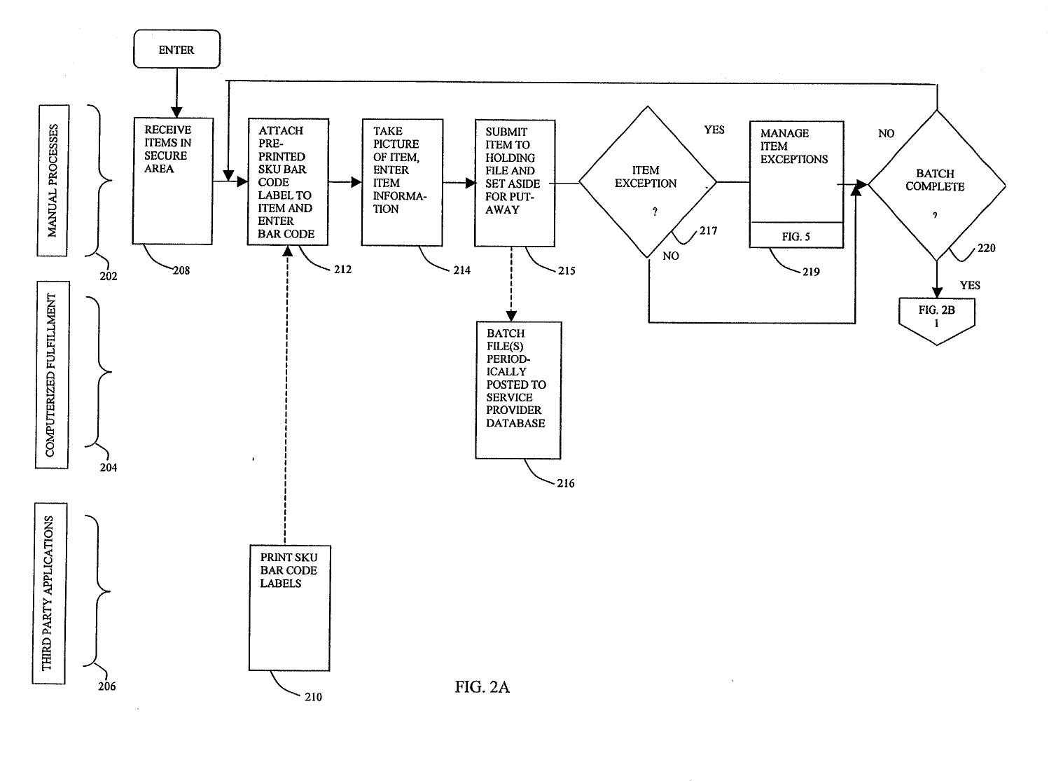

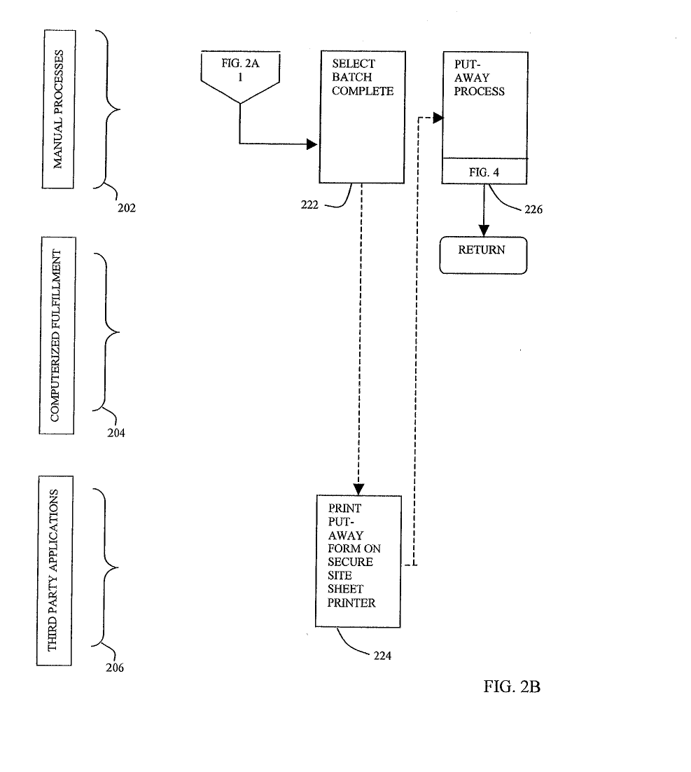

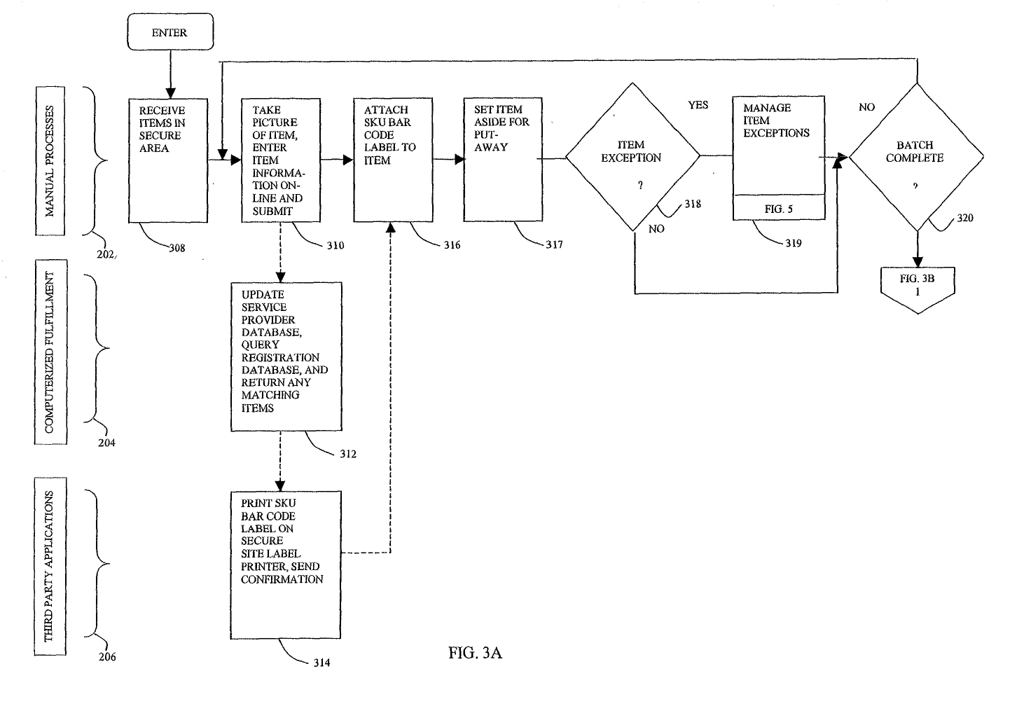

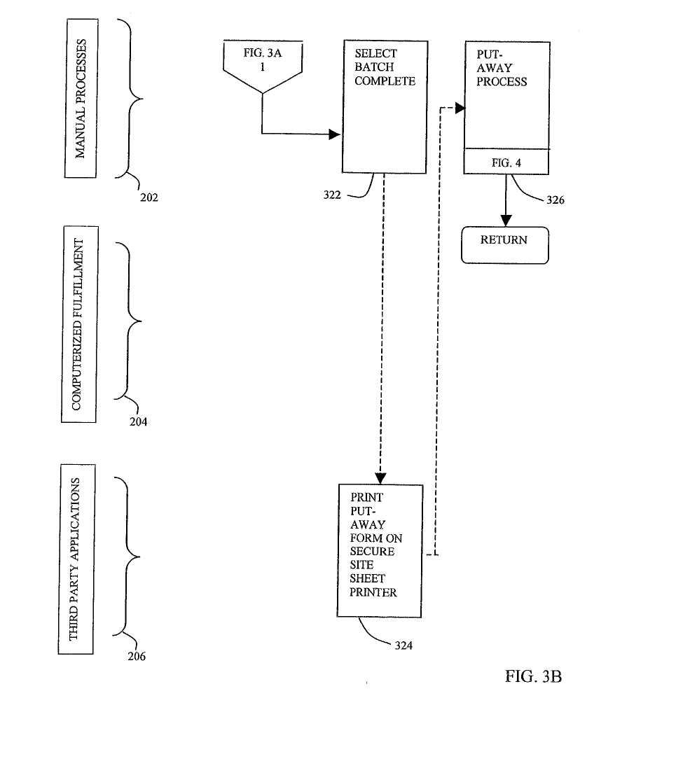

Step 106 calls the process of FIGS. 2A-B or FIGS. 3A-B where seized items are received by site personnel in the secure area, inventoried, and entered into the service provider inventory database. The processes of FIGS. 2A-B and FIGS. 3A-B are discussed in greater detail below.

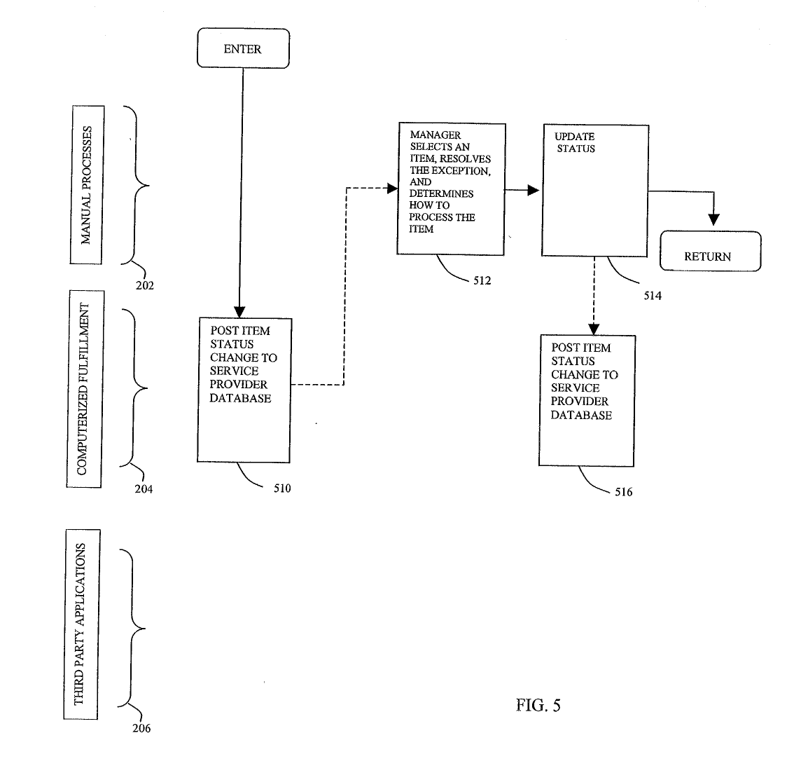

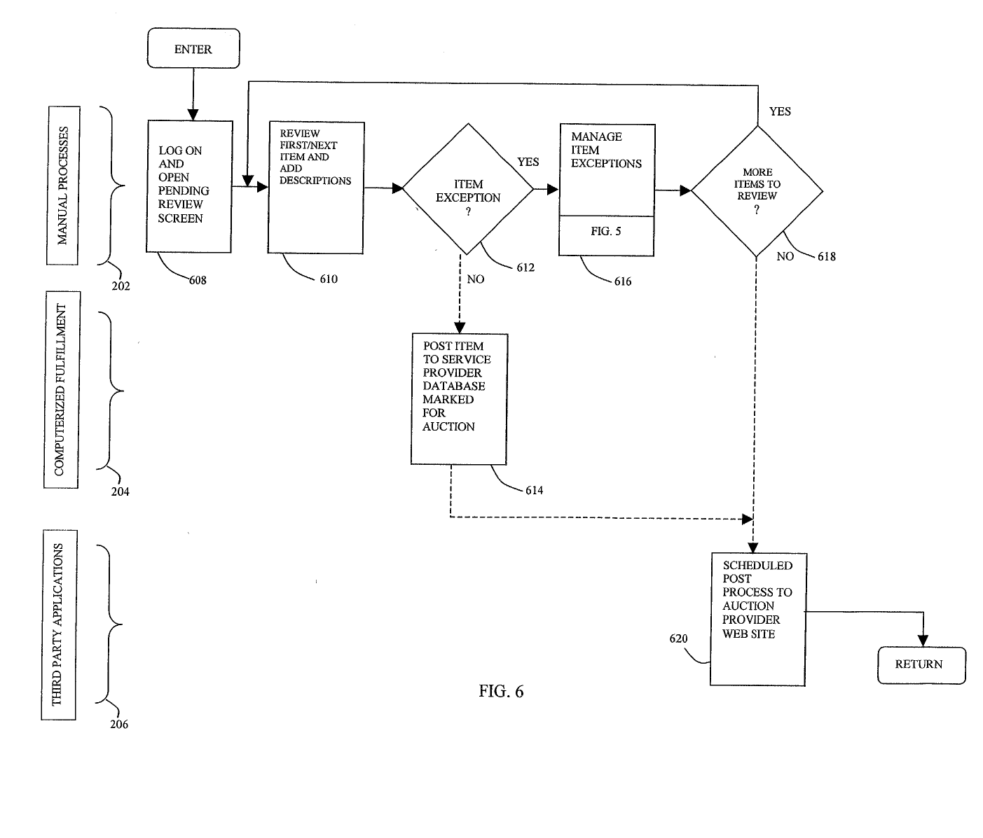

After returning from FIGS. 2A-B or FIGS. 3A-B, step 108 calls the process of FIG. 6 where appraisers employed by the service provider, referred to as E-Product Specialists, evaluate seized items, set a minimum price for each seized item to be sold, prepare the seized items for posting, and post the seized items for auction on the Internet auction web site. The process of FIG. 5 is discussed in greater detail below.

After returning from FIG. 6, in step 110 the seized items that have been posted are auctioned off on the Internet in a manner that is well known in the art. The service provider may perform this function from its own web site. In a preferred embodiment of the invention, an independent hosting company specializing in online auctions, referred to as the online auction provider, hosts the auction site on behalf of the service provider. An auction bidder has the ability to calculate shipping costs based on the auction bidder's location. Bidding may be denied to an auction bidder having a billing address which is undesirable for reasons such as, but not limited to, export controls, hazardous shipping controls, and non-shipping serviceable area. When an auction bidder places a bid on an item using a credit card, the online auction provider posts a charge on the credit card for $1.00 to verify that the card is legitimate and active. The credit card is not actually charged. The charging of a credit card is a two-part process: Post and Authorize. In one embodiment, the $1.00 charge is posted to the credit card. This has the effect of determining whether the credit card is valid. It will also put a lock on $1.00's worth of the credit card's limit. The hold on the $1.00 will last for about 24 hours and will disappear without an “Authorization,” the second part of the charging process. This procedure applies to all persons placing a bid on an item.

The credit card number is passed on to the service provider for processing the financial transaction. Once the auction is closed, the service provider is notified, via a tab-delimited file or XML (Extensible Markup Language) download of the winning auction bidder.

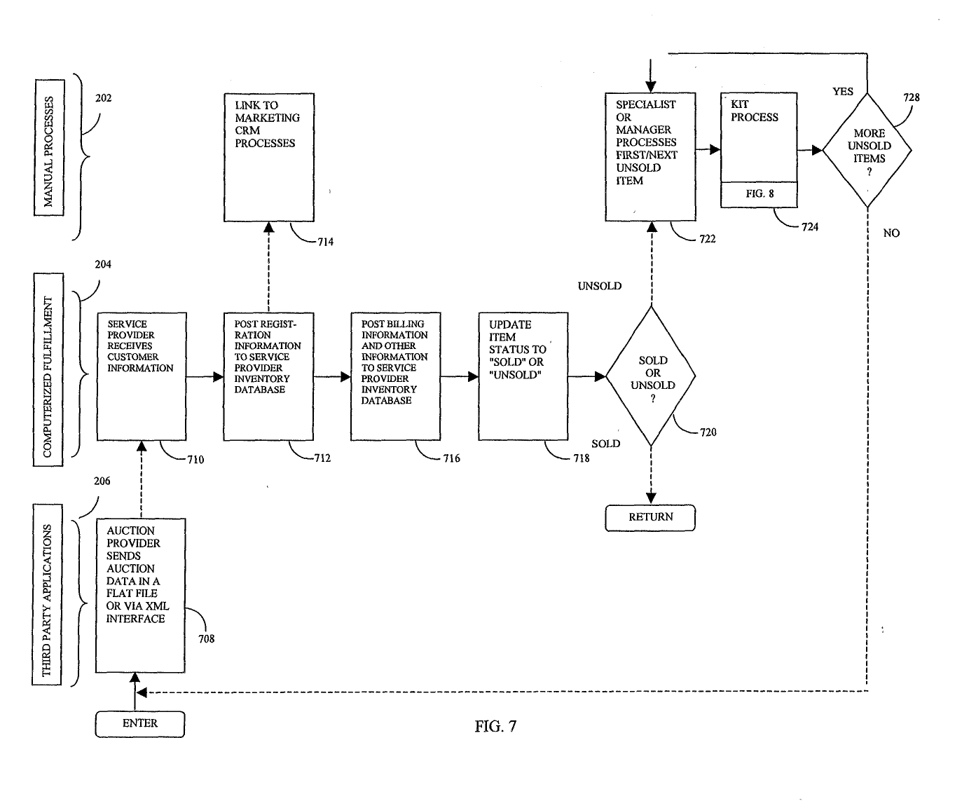

Step 112 calls the process of FIG. 7 where the winning bids are processed. The process of FIG. 7 is discussed in greater detail below.

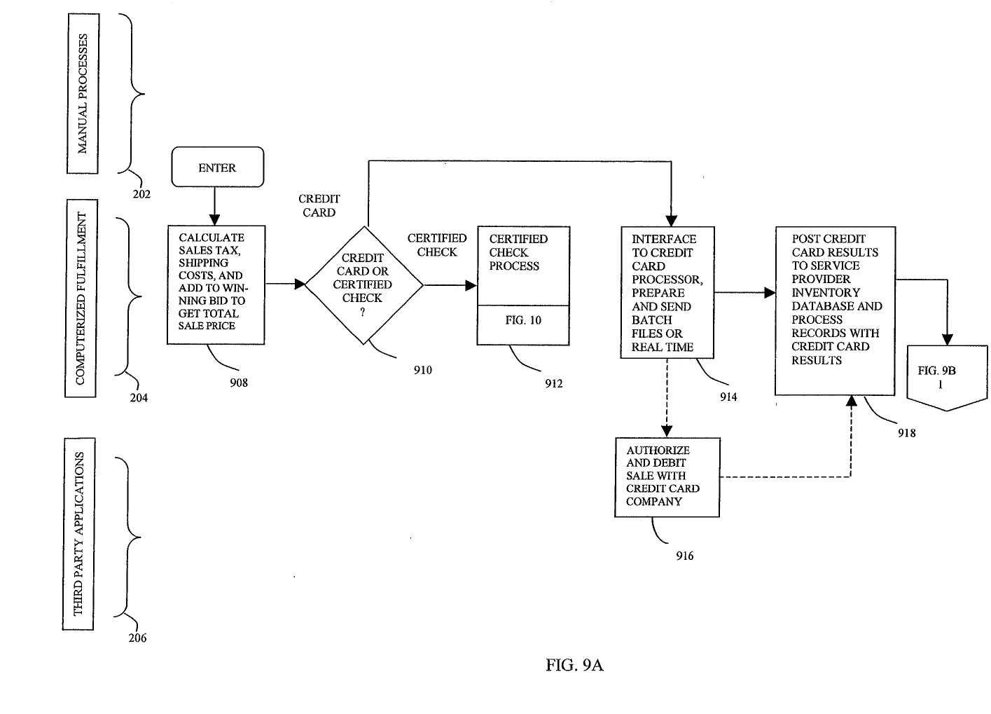

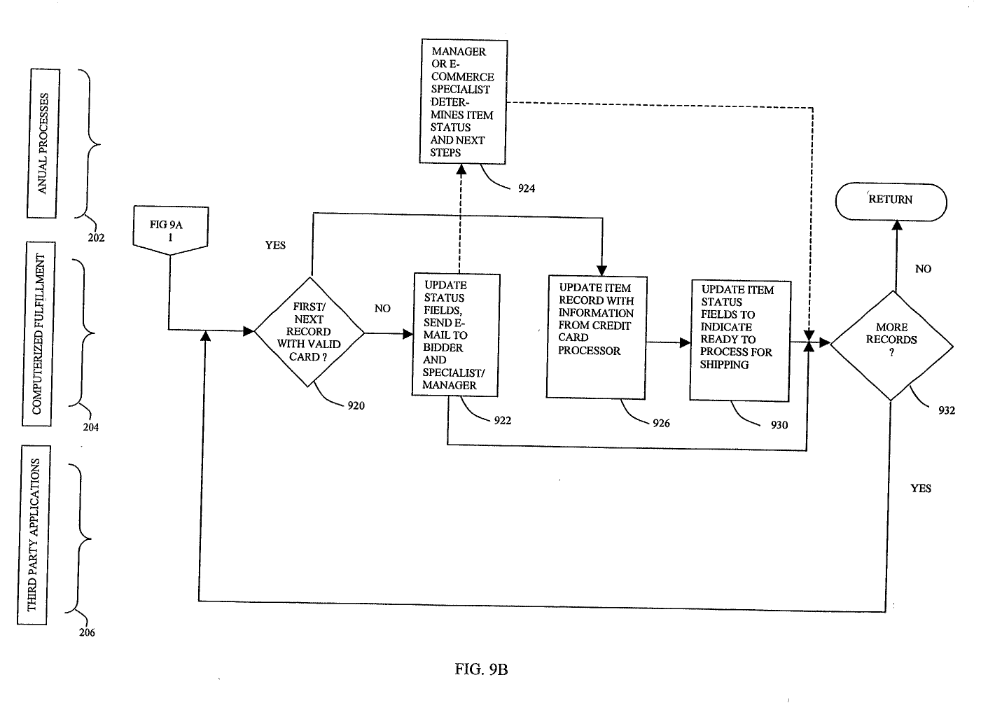

After returning from FIG. 7, step 114 calls the process of FIGS. 9A-B where payment for items sold at auction is collected, either by credit card or certified check. The process of FIGS. 9A-B is discussed in greater detail below.

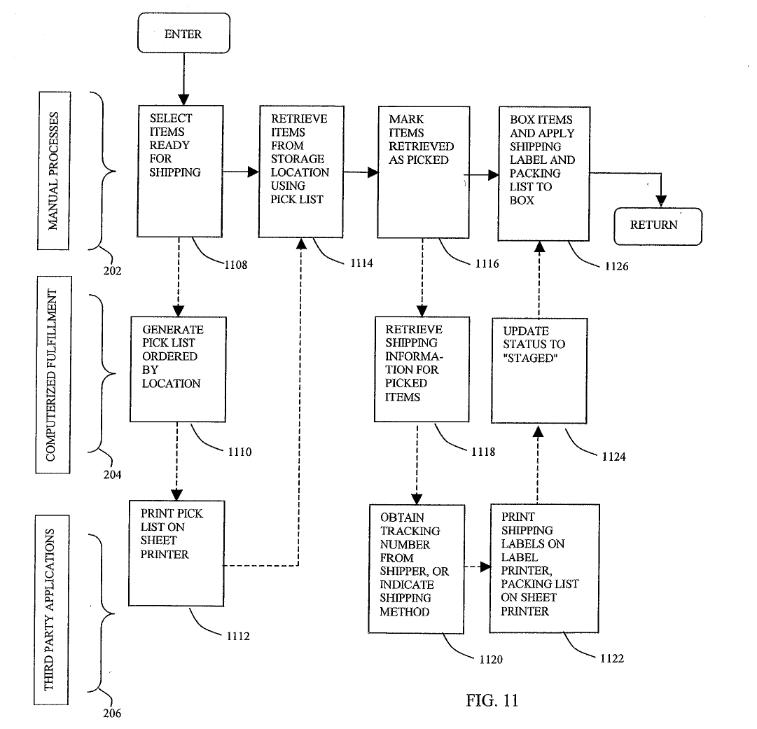

After returning from FIGS. 9A-B, step 116 calls the process of FIG. 11 where the items sold at auction are staged for shipping. Upon receiving payment, the service provider prompts the site personnel at the secure site where the item is stored to prepare the item for shipping. The process of FIG. 11 is discussed in greater detail below.

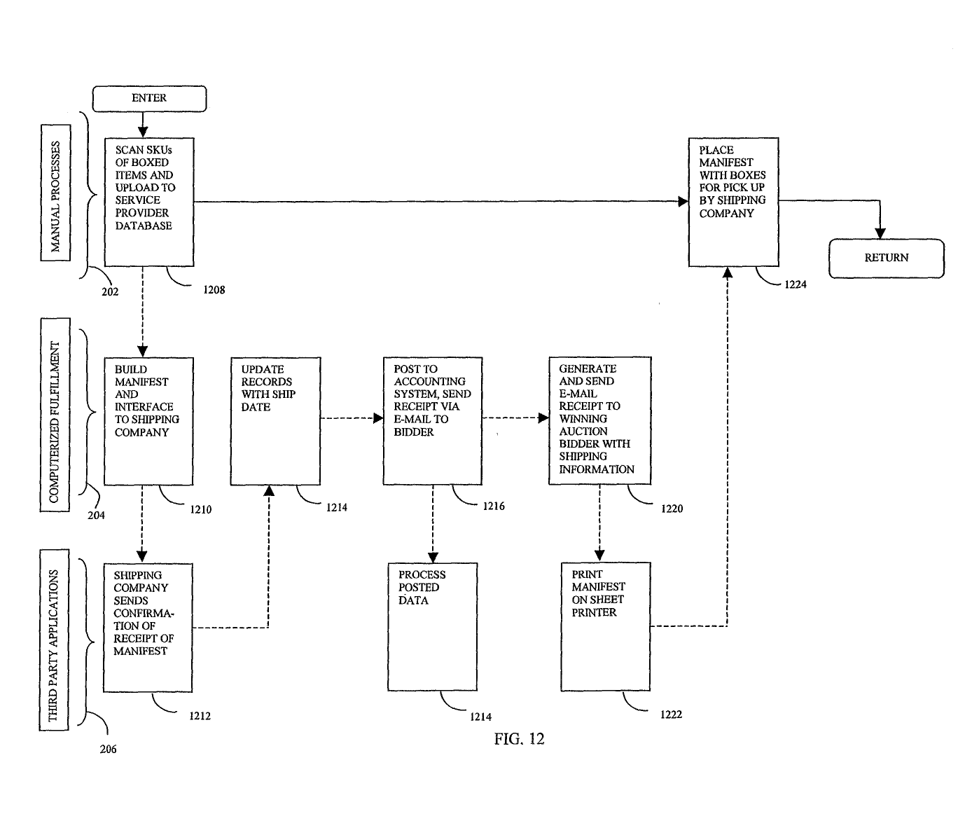

After returning from FIG. 11, step 118 calls the process of FIG. 12 where the items sold at auction are shipped to each winning auction bidder. Once the item is shipped, the site personnel notify the database, which causes an e-mail containing the pertinent shipping information to be sent to each winning auction bidder. The process of FIG. 12 is discussed in greater detail below.

After returning from FIG. 12, in step 120 revenue from the sale is recognized by the service provider and disbursements are made to the law enforcement or government agency pursuant to the contractual agreement. Revenue is recognized and allocated to the appropriate account. Typically, payment is made to the agency thirty days later or on a monthly basis.

In step 122 it is determined if there are more seized items available from the agency. If yes, then the process returns to step 106 for repetition of the processes of step 106 and following. If no, then in step 124 it is determined if there are more law enforcement and other government agencies with which to enter into contractual agreements. If yes, then the process returns to step 102 for repetition of the processes of step 102 and following. If no, then the method of the present invention ends. One skilled in the art will recognize that many different law enforcement and other government agencies may be contacted at the same time for the purpose of entering into a contractual relationship. Likewise, many different secure locations may be processing seized goods for auction at the same time. The methodology of the flow in FIG. 1 is shown for simplicity.

FIGS. 2A-B show a block flow diagram of the method of receiving goods, inventorying them by entering data on each item into a secure site computer, and uploading the data in a batch file to a remote computer system having a computer software application with an inventory database in an embodiment of the present invention. In FIGS. 2-12, manual processes are performed in blocks lying on the same horizontal row as indicated by manual processes indicator 202. Likewise, computerized fulfillment processes are performed in blocks lying on the same horizontal row as indicated by computerized fulfillment indicator 204. Finally, third party application processes are performed in blocks lying on the same horizontal row as indicated by third party applications indicator 206.

Referring now to FIG. 2A, which is called from step 106 of FIG. 1, in step 208, for a service provider owned secured site, a service provider employee drives to a law enforcement agency and picks up items released for auction. The service provider employee then brings the items for auction back to the service provider owned secure site and places them in an area for “un-cataloged” items. Alternatively, the agency may deliver the items to the service provider owned secured site. For a secure site provided for the service provider within a portion of the law enforcement or government agency space, a service provider employee receives items released for auction by the agency into the service provider's secure site.

SKU (Stock-Keeping Unit) bar code labels are generated in step 210 in batch format at the service provider's central location utilizing a third party application, and delivered in batches to each secure site. Each different government agency under contract is assigned a unique number that is a part of the SKU bar code number. For example, the first three digits of the bar code (alpha, numeric, or alpha/numeric) may be used to represent different agencies under contract with the service provider. This is especially useful at a secure site that receives seized items from more than one agency. The remaining characters, which may be alpha, numeric, or alpha/numeric, represent the individual item. An optional trailing character may serve as a checksum to confirm validity of the SKU number. An exemplary format for the SKU number is “XXX-XXXXX-X”. In another embodiment of the invention, the SKU bar code numbers and printed labels may be printed on demand at each individual secure site with printers attached to the secure site computer.

When items available for auction are received, site personnel catalog each item. The cataloging process begins in step 212 where items are taken from the “un-cataloged” area and brought to an area designated for photographing the items. A preprinted SKU bar code label can be attached by the site personnel to the item. This is typically done before the item is photographed, but may be applied after photographing.

A scanner connected to the secure site client computer system may be used to scan the SKU bar code number into an SKU field (inventory database field “ss SKU”) of a database record, or the SKU bar code number may be entered through the keyboard and/or mouse. The unique SKU bar code number may also be used to name the digital photographic image of the item, which is typically in a .jpg or .gif format or any other suitable graphics file format.

In step 214, a photograph is taken of each item. In a preferred embodiment of the invention, a digital photographic camera is used which plugs into the secure site computer through a USB port. When the picture is taken, the picture will be manually saved to the secure site computer and manually re-named by the site personnel. The picture will then be correlated to an item description through the web-wise application based upon the picture name and the SKU of the item entered.

In another embodiment, after a picture is taken a software program is launched which displays the picture on the computer monitor and prompts the site personnel to enter information using the computer keyboard and/or mouse into specified inventory database fields, such as item description, relative condition of item, value, dimensions, weight, quantity, special handling, case ID, notes, and SKU bar code number. One skilled in the art will recognize that many different types of inventory database fields may be used to capture various pieces of information about each item. The inventory database fields described herein are exemplary and not intended to be exhaustive in nature. Additionally, new inventory database fields may be added at any time as they become necessary, and old inventory database fields may be abandoned. Each inventory database field may be limited to a certain number of words or characters, or a certain type of character, such as alpha, numeric, or alpha numeric, as is well known in the art. In one embodiment of the invention, each inventory database field name includes an identifier indicating the source of the information, such as from the site personnel at a secure site (ss), from the online auction provider (oap), or from the service provider computer software application (sp).

The digital picture is a stored image field (inventory database field “ss picture”). A description of the item is entered in a description field (inventory database field “ss description”). The relative condition of the item is observed and the item is classified into one of a predetermined set of descriptions such as: excellent, very good, good, fair, and poor, which also may be accessed from a pull down list. A grading scale may also be used, indicating whether the item is new in its original packaging, new with no packaging, new but missing parts, new but damaged, used, used and missing parts, used and damaged, etc. The condition chosen is entered or selected from a pull down list in a relative condition field (inventory database field “ss relative condition”). A rough estimate of the item's value may be entered into a price field (inventory database field “ss price”).

If the item appears to be larger than a maximum size constraint of 130 inches for shipping purposes (length plus girth, where girth is two times the width plus two times the height) or otherwise bulky, the dimensions of the item are measured to determine the most appropriate method of shipping. The measurements are entered in inventory database fields for width, length, and height (inventory database fields “ss width”, “ss length”, and “ss height”). The item may also be weighed and the value rounded up to the nearest pound and entered into a weight field (inventory database field “ss weight”). The site personnel may enter any special handling instructions that may be necessary for shipping the item in a special field (inventory database field “ss special”).

The quantity of the item is entered into a quantity field (inventory database field “ss quantity”). Each item requires its own SKU number. If there are five identical items, the site personnel enter the item once and five different SKU labels with different SKU numbers are applied, one to each item.

A case ID field (inventory database field “ss case ID”) is used to enter the agency tracking number, if any, associated with the item. This tracking number may be a police case number that the piece of property emanated from or some other means of tying the item to governmental activity. This entry is valuable as it provides a complete audit capability on every item back to the source agency and case designation. Most current local auctions conducted on behalf of law enforcement or government agencies do not offer this audit capability because many items are sold in lots, offering little accountability. The case ID may be a bar code used by the law enforcement or government agency that is attached to the item. A scanner connected to the secure site client computer system may be used to scan the bar code into the “ss case ID” inventory database field. The site personnel may enter any special notes that are warranted by the item in a notes field (inventory database field “ss notes”). Fields for the brand name, model and serial number may also be used if those type of fields pertain to the item being cataloged.

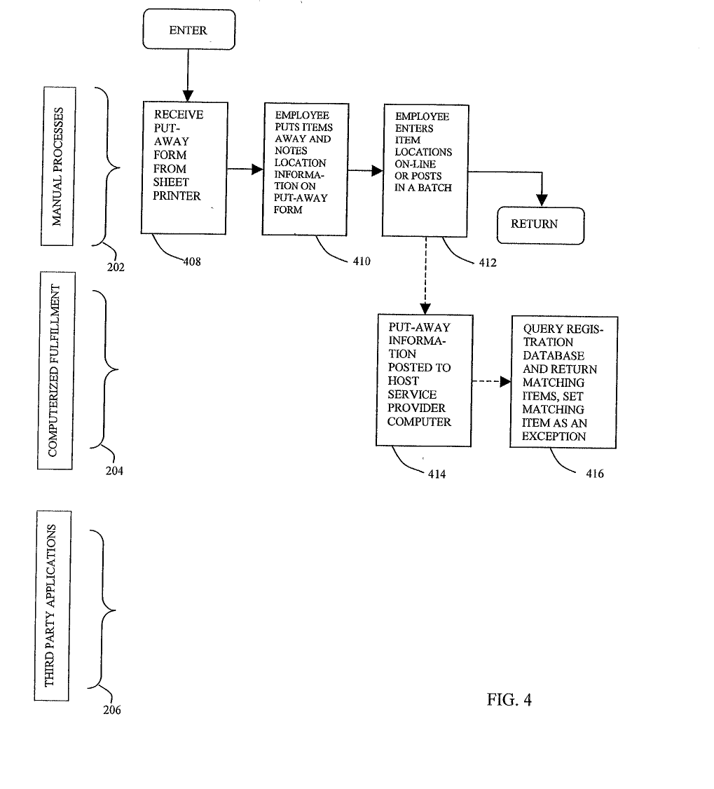

After all of the above information has been entered for an item, in step 215 the site personnel clicks the mouse button on a “submit” button displayed on the screen that adds the digital photographic image and the inputted information for the item to a batch file stored on the secure site computer. This batch file may be added to throughout the day as additional items are processed. When the data input for each item is completed, the site personnel sets the item aside in a special holding area until the item can be put-away. The put-away process is described below in the discussion of FIG. 4.

Step 217 determines if there is an exception encountered in cataloging an item. If no exception is encountered, control flows to step 220. If an exception is encountered, then step 219 calls the process of FIG. 5 where item exceptions are handled. The process of FIG. 5 is discussed below. After returning from FIG. 5, control flows to step 220.

Decision step 220 determines if the current batch of seized items have all been entered. If not, then control returns to step 212 where the site personnel attaches a preprinted SKU bar code label to the next item in the batch and repeats the subsequent acts in the cataloging process. If in step 220 the determination is that the current batch of items is complete, then in step 222 (FIG. 2B) the site personnel clicks the mouse button on a “Batch Complete” button displayed on the screen, which causes a put-away form to be printed out on a sheet printer at the secure site in step 224. One skilled in the art will recognize that efficiencies in time may be obtained by processing multiple items simultaneously. For example, pictures may be taken of several items, multiple pictures moved to the computer at one time, and item information added in groups. Step 226 then calls the put-away process of FIG. 4, which is discussed below. Upon returning from FIG. 4, control returns to step 108 of FIG. 1.

At a predetermined time in the evening, at night, or specified intervals, in step 216 the secure site computer transmits, or posts, the batch file or files containing all the digital photographic images and associated inventory information input since the last upload of any batch files to the service provider computer software application via a 56K modem or any other suitable hardware and communications channel. The service provider inventory database adds a date and time stamp to each new entry from the uploaded batch file or files in a post date field (inventory database field “sp post date”) and a post time field (inventory database field “sp post time”). Upon successful transfer of the batch file or files to the service provider inventory database, the inventory database issues a confirmation to the originating secure site which is stored in a confirmation field (inventory database field “sp confirmation”). When a new item record is created, a key field (inventory database field “ss key”) is set with a default value. This field is used to generate reports for the E-Product Specialist.

FIGS. 3A-B show a block flow diagram of the method of receiving goods and inventorying them by entering data on each item online in real time from a client computer using an Internet/Intranet web-based computer software application hosted at a server computer having an inventory database in an embodiment of the present invention. Referring now to FIG. 3A, which is called from step 106 of FIG. 1, in step 308, for a service provider owned secure site, site personnel drive to a law enforcement or other government agency and pick up items released for auction. Site personnel then bring the items for auction back to the service provider owned secure site and place them in an area for “uncataloged” items. Alternatively, the agency may deliver the items to the service provider owned secured site. For a secure space provided for the service provider within a portion of the agency space, site personnel receive items released for auction by the agency into the service provider's secure site.

When items available for auction are received, site personnel catalog each item. The cataloging process begins in step 310 where items are taken from the uncataloged area and brought to an area designated for photographing the items. In a preferred embodiment of the invention, a digital photographic camera is used which plugs into the secure site client computer through a USB port. The site personnel establishes a connection to the host service provider computer via an Internet connection, and a web page is returned to the secure site client computer. The site personnel modifies the host service provider computer inventory database via an item entry applet that runs when the web page is returned to the secure site client computer. A cookie is set with a number for each secure site that is part of the service provider system. The cookie is accessed when the applet is launched. The secure site number is necessary for SKU generation. In another embodiment of the invention, the SKU bar code numbers and printed labels may be generated in batch format at the service provider's central location utilizing a third party application, and delivered in batches to each secure site. In such a case, the preprinted SKU bar code labels would be applied prior to taking the digital picture.

After the item entry applet launches, the picture from the attached digital photographic camera is displayed on screen in a frame of the web page, and the site personnel is prompted to enter information through the client computer keyboard and/or mouse into specified inventory database fields for an item record as described above in relation to step 214 of FIG. 2A. After entering all the required information, the site personnel clicks the mouse button on a “submit” button on the web page displayed on the screen, which transmits the data to the host service provider computer.

In step 312, the host service provider computer is updated with the data transmitted by the site personnel, and then queries the registration database to see if any of the items in the data received matches any of the stolen items in the registration database. If there is a match, the site personnel where the matched item or items are located is notified, and the site personnel makes arrangements with the rightful owner to receive their stolen items back. If there is no match, the host service provider computer is prompted to issue a SKU number that is stored in the item record in the service provider inventory database.

In step 314 the SKU number assigned is immediately printed on a SKU bar code label at the secure site on a label printer. The host service provider computer makes note of the date and time of successful item entry utilizing a date field and a time field (inventory database fields “sp date” and “sp time”). The unique SKU bar code number may also be used to name the digital image of the item, which is typically in a .jpg or .gif format, or any other suitable graphics file format. The printing of the SKU bar code label is the final portion of the transaction. The SKU bar code label printing out is the acknowledgment that the inventory database has been successfully updated. In the case where SKU labels are pre-printed, the screen will display an “Item Submitted Successfully” screen prior to the prompting of entering another item. The service provider inventory database then generates a confirmation number and sends the number to the secure site client computer utilizing a confirmation field (inventory database field “sp confirmation”).

In step 316 the printed SKU bar code label is attached by the site personnel to the item. The site personnel then sets the item aside in step 317 in a special holding area until the item can be put-away. The put-away process is described below in the discussion of FIG. 4.

Step 318 determines if there is an exception encountered in cataloging an item. If no exception is encountered, control flows to step 320. If an exception is encountered, then step 319 calls the process of FIG. 5 where item exceptions are handled. The process of FIG. 5 is discussed below. After returning from FIG. 5, control flows to step 320.

Decision step 320 determines if the current batch of seized items have all been entered. If not, then control returns to step 310 where the site personnel takes a digital picture of the next item in the batch and repeats the subsequent actions in the cataloging process. If in step 320 the determination is that the current batch of items is complete, then in step 322 (FIG. 3B) the site personnel clicks the mouse button on a “Batch Complete” button on the web page displayed on the screen, which causes a put-away form to be printed out on a sheet printer at the secure site in step 324. One skilled in the art will recognize that decision step 320 and step 322 can be made at any point in time. It is not necessary to wait for all the items of a specific agency to be done in order to start putting items away, nor is it necessary to research all exceptions. Step 326 then calls the put-away process of FIG. 4, which is discussed below. Upon returning from FIG. 4, control returns to step 108 of FIG. 1.

FIG. 4 shows a block flow diagram of the put-away process of the present invention. Referring now to FIG. 4, after being called from step 226 in FIG. 2B or step 326 in FIG. 3B, in step 408 the put-away form is retrieved by the site personnel from the sheet printer. The put-away form contains a limited number of filled in inventory database fields so that the site personnel has enough information to identify each item to be put-away. The form also contains blank spaces corresponding to inventory database fields that the site personnel fills in as each item is taken from the special holding area to the put-away area.

A pick location is defined as the physical location of an item in the secure site. A specialized number is used to define pick locations based on the layout and organization of the storage space dedicated for storing cataloged items. Pick locations are typically assigned an eight digit number made up of four two-digit number segments, such as AA-BB-CC-DD, where AA represents the aisle, BB represents the section of the aisle, CC represents the shelf in the section, and DD represents the slot in the shelf. The aisle, section, shelf, and slot fields (inventory database fields “ss aisle”, “ss section”, “ss shelf”, and “ss slot”) are defined to receive each segment of the pick location number. In step 410 the site personnel puts each item away, and the appropriate aisle, section, shelf, and slot number is filled in on the put-away form.

In step 412 the site personnel accesses a put-away report page displayed on the monitor of the secure site client computer and enters the pick location numbers in the proper inventory database fields for each item online or utilizing a batch process. When the put-away report is complete, in step 414 the put-away report is posted to the host service provider computer, where the new information is added to the appropriate item records in the inventory database. Control then returns to either step 226 of calling FIG. 2B or step 326 of calling FIG. 3B.

The service provider maintains a registration database that may be accessed by individuals and companies who have had items stolen. In a preferred embodiment, the registration database is made available to the public through a web site accessible over the Internet. Individuals can register their stolen merchandise by listing the serial number of the item or other pertinent information that could positively identify their stolen goods, creating a record in the registration database. Other information may include model number, personal identification number, police case report number, general description of the item, etc. The individual or company name, address, telephone number, and other contact information is also stored.

In step 416, the batch file received is compared to the registration database to see if any of the items cataloged match any of the stolen items in the registration database. If there is a match, the matching item is set as an exception and the site personnel where the matched item or items are located is notified. The site personnel makes arrangements with the rightful owner to receive their stolen items back.

FIG. 5 shows a block flow diagram of handling item exceptions of the present invention. Reasons for an exception include no basis to establish a price for the item or the item needs to be sold with one or more other items not yet available. Other reasons for exceptions include shipping problems such as hazardous materials, export issues, bulky item, or excess weight. An exception may also include a jewelry item awaiting appraisal. After the auction, exceptions would include an invalid shipping address or an inability to charge the credit card. One skilled in the art will recognize that exceptions may by handled at various stages in the process besides the ones already mentioned.

Referring now to FIG. 5, which is called from step 219 of FIG. 2A, from step 319 of FIG. 3A, or from step 616 in FIG. 6, in step 510 the exception status change for the item or items is posted to the service provider database. In step 512 a manager for the service provider will view a list of items having the status of “Exception.” The manager will then select an exception item and attempt to resolve whatever problem caused the exception, and determine how to process the item. If the issue is not resolved by the manager, the status will remain “Exception.” In step 514, if the exception issue is resolved, the manager will change the “Exception” status of the item back to “ReadyForReview.” Upon changing the status, in step 516 the item status change is posted to the service provider inventory database and re-enters the process at “ReadyForReview” stage. Control then returns to step 220 of calling FIG. 2A, step 320 of calling FIG. 3A, or step 618 of calling FIG. 6.

FIG. 6 shows a block flow diagram of the item review process of the present invention. The E-Product Specialist reviews all items that have been uploaded to the inventory database prior to posting them to the Internet auction web site. The E-Product Specialist may add various descriptions and set one or more of the following: set a bid category, enter up to three descriptions for each item, specify the type of auction, set an opening bid price, set a bid increment, set a bid reserve, set a maximum bid amount, set an auction length, specify shipping stipulation, and add to the notes fields (“ss special” and “ss notes”). The E-Product Specialist has access to previous winning bids for similar or related items as an aid in current item pricing.

Referring now to FIG. 6, which is called from step 108 in FIG. 1, in step 608 the E-Product Specialist starts by logging into the host service provider computer from the secure site client computer or from some other computer networked to the secure site client computer. The E-Product Specialist then opens a pending review web page, which pulls up all the items that have been posted to the service provider inventory database from the secure site client computer but not yet reviewed by an E-Product Specialist. This listing typically appears with the oldest items on the top of the list and newest items at the bottom of the list.

In step 610 the E-Product Specialist opens the record for the oldest item at the top of the list and starts the review process by looking at the digital picture of the item and reading the descriptions entered by the site personnel. The E-Product Specialist is able to view portions of the data entered by the site personnel on the web page. In one embodiment of the invention, the inventory database fields viewable include “ss description”, “ss notes”, “ss relative condition”, “ss quantity”, and “ss special.” The E-Product Specialist uses this information to update the record with auction specific data.

The bid category may be selected from a set of pre-specified categories. In one embodiment of the invention, there are five layers of categories for the E-Product Specialist to work through, where the first category is very generic and the fifth is quite 0 specific. The five category layers “pop up” on the web page or may be accessed from pull down lists on the web page and selected with the mouse. As an example, “Electronics and Photo” is one type of a Category One category (inventory database field “sp cat one”). “Photography” is one type of a Category Two category (inventory database field “sp cat two”), which is a sub-category of Category One. “Cameras” is one type of a Category Three category (inventory database field “sp cat three”), which is a subcategory of Category Two. “35 mm SLR” is one type of a Category Four category (inventory database field “sp cat four”), which is a sub-category of Category Three. Finally, “Nikon” is one type of a Category Five category (inventory database field “sp cat five”), which is a sub-category of Category Four. These categories may be extended downward more levels as necessary.

The E-Product Specialist may write one or more descriptions for the items. In one embodiment of the invention, three descriptions are required for each item. The first is short, much like the top layer category, approximately two words in length (inventory database field “sp des one”). The second description appears much like the fifth level category title, and may be up to ten words in length (inventory database field “sp des two”). The third description is very specific to the item. This description can be very long, up to the limit built into the particular database used (inventory database field “sp des three”). The inventory database allows the creation of new categories at all levels by the inventory database administrator.

The E-Product Specialist may set the type of auction, such as English, Dutch, Quick Win, Auto Markdown, and various other variations of these. The E-Product Specialist may set the opening bid price. As an aid in determining the opening bid price, the E-Product Specialist has access to items previously sold in the same category, their winning bid price, and the long description. This information is accessed by clicking the mouse button on a “hot” button on the web page displayed on the screen. The E-Product Specialist also has access to numerous catalogs online and printed catalogs located physically where the E-Product Specialist is working. The opening bid amount is a rounded dollar amount (inventory database field “sp open price”).

The bid increment amount is typically set by default based on the opening bid for the item (inventory database field “sp increment”). However, the defaults may be overridden by the E-Product Specialist in special situations. An example of price/default bid increments are: $0-$99/$1; $100-$249/$2.50; $250-$499/$5; $500-$999/$10; $1000-$2499/$25; $2500-$4999/$50; and $5000+/$100.

A bid reserve price may be set by the E-Product Specialist. A bid reserve price is a price the bidding must exceed before a winner is declared. For example, if a baseball card has a bid reserve price of $20 and bidding opens at $10, then a bid exceeding $20 must be made before a winner is declared. If bidding does not exceed $20 during the allotted time for the auction (for example, 10 days), no winner is declared. If a bid reserve price is deemed necessary, the reserve price is typically a set percentage above the opening bid. This field has a Yes/No type option. The default setting for this field is “no” (inventory database field “sp reserve”). A yes value in this field is used as a key to calculate the actual reserve price (inventory database field “sp reserve price”) based upon a predetermined percentage. In another embodiment of the invention, bid reserve prices may be set according to previous winning bids of similar items. The “sp reserve price” inventory database field with the calculation result is viewable by the E-Product Specialist on the web page displayed on the screen.

A maximum bid price may be set based upon pricing information obtained in the previous steps. A Yes/No value in a maximum bid field (inventory database field “sp max bid”) is used to trigger a price calculation for a maximum bid price for an item (inventory database field “sp max bid price”). The maximum bid price is a “sale” price. If the maximum bid price is reached, the auction closes and the bidder who bid the maximum bid price is an instant winner. The maximum bid price is determined typically by a set percentage above the opening bid amount. In another embodiment of the invention, the maximum bid price may be determined according to previous winning bids of similar items. The default setting for the “sp max bid price” inventory database field is none, and a “yes” value in the “sp max bid” inventory database field triggers the calculation of the maximum bid price. The calculated value for the “sp maximum bid price” inventory database field is viewable by the E-Product Specialist on the web page displayed on the screen.

The auction length (time) has a default setting of ten days (inventory database field “sp length”) with other time options available, such as a 24 hour “flash” auction. Another option is hold for review (inventory database field “sp hold”). Hold for review puts the record aside and causes the record to appear in a special report. The hold for review option is for items that do not sell after the ten-day auction period or the 24 hour flash auction period. Items may also be placed in hold for review status for other reasons, such as holding for ideal market timing, or to group items for a sale. Items may also be placed in hold for review until shipping or packaging issues are resolved.

Shipping stipulations (inventory database field “sp shipping stip”) may be determined by the E-Product Specialist. Shipping stipulations include items that can be shipped internationally (default), domestic only, or export only.

The following fields may be available to the E-Product Specialist, and typically have set defaults. The fields are necessary for moving an item to the online auction provider's web site and taking the item live. The fields include, but are not limited to, the fields shown below.

A service provider date available (inventory database field “sp data available”) is the date that the item is available to go live on the Internet auction web site. By default, this date is set as the day of or day following the record update as performed by the E-Product Specialist.

A service provider open date (inventory database field “sp open date”) is the date the item goes live on the auction. By default, this date is set as the day of or day following the record update as performed by the E-Product Specialist.

A service provider close date (inventory database field “sp close date”) is the date when the auction is to close. By default, all auctions are set at 10 days. The date in this field is the service provider open date plus 10 days.

A service provider open time (inventory database field “sp open time”) is the time at which bidding is allowed to start on the item.

A service provider close time (inventory database field “sp close time”) is the time at which bidding stops on the item. The online auction provider default time is typically used, assuming a default time is set if no time is supplied. An appropriate time of closing is used to allow the maximum number of last minute bids.

A service provider minimum quantity (inventory database field “sp min quantity”) is the minimum number of identical items available for the auction under that listing. The default is set at one.

A service provider shipping methods (inventory database field “sp shipping methods”) are the methods by which the item can be shipped. By default, the methods available are UPS ground, UPS Second Day, USPS Priority Mail, and FedEx next day. The other options available are common carrier and pickup.

The following are fields that may be generated automatically by the host service provider computer inventory database.

A SKU.jpg (inventory database field “SKUjpg”) is a field used to identify the image associated with the item. By default, the name of the image is the SKU followed by “.jpg” (e.g., XXXXXXXX.jpg, or XXX-XXXXX-X.jpg if a trailing character is used as a checksum). There is also a database field for storing the images, (inventory database field “ss image”).

A secure site location (inventory database field “ss location”) is a field generated by the host service provider computer by looking up the first three digits of a SKU number and matching it to a city, state, and zip code file.

The E-Product Specialist ideally moves through these web pages as quickly as possible. The result of various calculations appear on the web page while not updating the inventory database until an “update” button is clicked on with the mouse, which indicates that the E-Product Specialist is done entering information. There is a warning if the E-Product Specialist tries to leave the web page without clicking the “update” button. Once the record is successfully updated, the “sp specialist key one” inventory database field is modified to indicate the record is ready to be posted to the online auction provider for online processing. The “sp batch” inventory database field is modified indicating the record is ready to be posted to the Internet auction web site in batch format for batch processing. In another embodiment of the invention, items may be sent to the Internet auction web site in real time. When the “update” button is pressed, the database will process the information and send it immediately. The real time files are presented via an XML interface. The service provider inventory database can handle both the online or batch postings.

Step 612 determines if there is an exception encountered in reviewing an item that has not been previously determined. If no exception is encountered, control flows to step 614. If an exception is encountered, then step 616 calls the process of FIG. 5, described above, where item exceptions are handled. After returning from FIG. 5, control flows to step 618.

In step 614, for online processing, the item reviewed is posted to the service provider inventory database marked for auction. For batch processing, the item is marked for auction and held in a batch file until the last item in the batch is processed. Then, the entire batch file is posted to the service provider inventory database (the batch process is not shown in FIG. 6).

Step 618 determines if there are more items to be reviewed by the E-Product Specialist. If yes, control returns to step 610 where the next item is reviewed and the subsequent actions are repeated. If there are no more items to review, then in step 620 the service provider inventory database looks for items that are marked for auction. Each record marked for auction is additionally marked to be included in an upload batch report to the online auction provider (inventory database field “sp batch”) which is uploaded to the online auction provider's web site on a scheduled basis. This may be once a day, as often as desired, or when the number of records posted reaches a specified amount (inventory database field “sp batch limit”). The batch file is typically presented in a tab-delimited format to the online auction provider whereas the real time uploads are done via an XML interface.

In addition, in special circumstances, items may be posted manually by the E-Product Specialist to the online auction provider (not shown in FIG. 6). The E-Product Specialist accesses a report listing the records marked for posting (inventory database field “sp specialist key one”) to select an item for manual uploading. After uploading records to the online auction provider in step 620, control returns to step 110 of FIG. 1.

FIG. 7 shows a block flow diagram of processing auction data from the online auction of the present invention. Referring now to FIG. 7, which is called from step 112 of FIG. 1, in step 708 any auction data that is collected by the online auction provider is provided to the service provider through a report. In one embodiment, the report is contained in a tab-delimited “flat file”, which is provided to the service provider automatically from the online auction provider on a daily basis. The flat file may also be retrieved manually from the online auction provider web site, or the service provider may query the online auction provider web site for items that have sold on a periodic basis. In a preferred embodiment, auction data is transferred to the inventory database through an XML interface and information is transferred in real time, whenever and immediately after an auction closes.

Auction participants, referred to as “bidders” are encouraged to register a username and to supply some information about themselves upon viewing the online auction provider web page. If they chose to register, the online auction provider collects Registration Information, and makes it available to the service provider though the flat file or XML interface. The Registration Information may include, but is not limited to, the following:

Username—A unique screen name to identify the bidder (inventory database field “oap username”);

E-mail address—This is the e-mail address to which most of the communication between the online auction provider/service provider and the bidder takes place (inventory database field “oap email”);

First Name—The first name of the bidder (inventory database field “oap fname”);

Last Name—The last name of the bidder (inventory database field “oap lname”);

Shipping Company—The company the bidder is affiliated with or employed by, if any (inventory database field “oap company”), or the company to which the item is to be shipped;

Shipping Phone No—The phone number of the winning auction bidder (inventory database field “oap phone”);

Shipping Address 1—The shipping street address to where the bidder wants the item shipped (inventory database field “oap address one”);

Shipping Address 2—The alternate or second line of a street address to where the bidder wants the item shipped (inventory database field “oap address two”);

Shipping City—The city to where the bidder wants the item shipped (inventory database field “oap city”);

Shipping State—The state or province to where the bidder wants the item shipped (inventory database field “oap state”);

Shipping Zip Code—The zip code or province code to where the bidder wants the item shipped (inventory database field “oap zip”); and

Shipping Country—The country to where the bidder wants the item shipped (inventory database field “oap country”).

When the bidder places a bid, the bidder is required to enter credit card information along with a billing address. This Billing Information is stored by the online auction provider until the bidder wins an auction. When the auction is over, the Billing Information is provided to the service provider through the flat file or XML interface. The flat file has a record containing the Registration Information, as described above, along with the new Billing Information. Care is taken not to duplicate bidder information since some of the information is entered into the service provider inventory database when the bidder registers, and is repeated in the Billing Information after an auction closes. The Billing Information collected may include, but is not limited to, the following:

Quantity Won—This refers to the number of identical items the winning auction bidder has won (inventory database field “oap qty won”);

Bid Amount—The dollar amount of the winning bid that is to be charged to the winning auction bidder (inventory database field “oap win bid”);

Shipping Method—The bidder's preferred shipping method to ship the item (inventory database field “oap ship method”);

Shipping Charge—The amount the bidder was quoted for shipping and handling by the online auction provider shipping software (inventory database field “oap ship charge”);

Credit Card Number—The credit card number to be used to pay for the item (inventory database field “oap cc”);

Credit Card Type—The brand of the credit card to be used to pay for the item (inventory database field “oap card”);

Credit Card Expiration Date—The expiration date of the credit card to be used to pay for the item (inventory database field “oap cc date”);

Amex CID—The four digit number that appears on the face of the American Express card and above the credit card number on the right (inventory database field “oap cid”);

Billing Name—The name as it appears on the credit card, first name and last name (inventory database field “oap bname”);

Billing Address—The billing address of the credit card to be used to pay for the item (inventory database field “oap baddress”);

Billing City—The billing city of the credit card to be used to pay for the item (inventory database field “oap bcity”);

Billing State—The billing state or province of the credit card to be used to pay for the item (inventory database field “oap bstate”);

Billing Country—The billing country of the credit card to be used to pay for the item (inventory database field “oap bcountry”); and

Billing Zip Code—The zip code or province code of the credit card to be used to pay for the item (inventory database field “oap bzip”).

In addition to the Registration Information and the Billing Information, the online auction provider provides Other Information to help with tracking and/or report creation. The Other Information provided includes, but is not limited to, the following:

Lot Number—The specific item auction number assigned by the auction hosting company (inventory database field “oap lot”);

Bid Number—Referrers to a specific bid that has been placed at the auction hosting company and is used primarily by the hosting company (inventory database field “oap bid number”);

Lot Title—Equivalent to the service provider's second description “sp des two” (inventory database field “oap lot sp two”);

Close Date—The date the auction is set to close (inventory database field “oap close”); and

Bid Site—The web location of the winning auction bidder, which is blank or is the primary auction this bidder is registered to (inventory database field “oap site”).

In addition to the above, the SKU/Item# (inventory database field “SKU”) is also contained in the flat file. The flat file may also contain five service provider definable fields. The five fields are:

Service Provider Data 1—(inventory database field “oap d1”);

Service Provider Data 2—(inventory database field “oap d2”);

Service Provider Data 3—(inventory database field “oap d3”);

Service Provider Data 4—(inventory database field “oap d4”); and

Service Provider Data 5—(inventory database field “oap d5”).

The contents of the flat file are received by the service provider in step 710 or are received through the XML Interface. Customer numbers are assigned to each winning auction bidder (inventory database field “sp customer number”) and, along with the Registration Information, is posted to the service provider inventory database in step 712. Once the Registration Information has been posted to the service provider inventory database, in step 714 site personnel, E-Product Specialists, or managers for the service provider may “mine” the service provider inventory database for marketing and Customer Resource Management (CRM) purposes. The service provider inventory database may be queried in many different ways to determine auction bidder history and tendencies, and to develop marketing tools and strategies. The Billing Information and the Other Information are posted to the service provider inventory database in step 716.

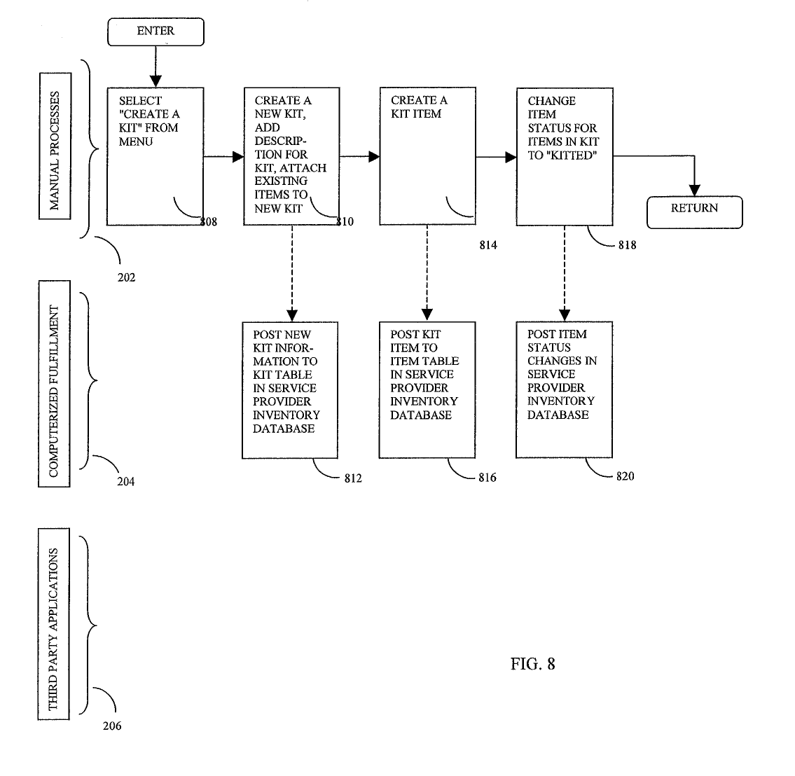

In step 718 the status of each item is updated in the service provider inventory database to reflect either “sold” or “unsold.” For items marked “sold”, control returns to step 114 of FIG. 1. For items marked “unsold”, in step 722 an E-Product Specialist or a manager for the service provider processes all the “unsold” items. Some items may be resubmitted for auction as is. Other items may be written off and marked for disposal, either to be thrown away or donated to charity. Other items may be turned into a kit by combining them with other items within the system. A kit is a combination of one or more items from one or more sites that form a logical selling unit. Step 724 calls the kit process of FIG. 8, which is discussed below. Upon returning from FIG. 8, step 728 determines if there are more “unsold” items to process. If yes, control returns to step 722. If it is determined in step 728 that there are no more “unsold” items to process, then control returns to step 708 for the next download of auction data.

FIG. 8 shows a block flow diagram of the process of creating a kit of the present invention. Referring now to FIG. 8, in step 808, which is called from step 724 of FIG. 7, the E-Product Specialist or a manager for the service provider, utilizing the secure site client computer, selects a “Create a Kit” option from a menu on a web page displayed on the client computer monitor. The kitting process may also be invoked by the site personnel. In step 810 a new kit is created. For example, one secure site might have an unsold computer, another secure site might have an unsold keyboard and a mouse, and a third secure site might have an unsold printer. Or, all of these unsold items may be located at the same secure site. The E-Product Specialist or manager may combine these separate unsold items into a kit, forming a complete computer system package. A description of the “kitted” items is developed by the E-Product Specialist, and the individual items are linked together to form the new kit. In step 812 the new kit information is posted to a kit table within the service provider inventory database.

In step 814 a kit item is created for the new kit. The kit item is posted to an item table within the service provider inventory database in step 816. Finally, in step 818, the item status for each of the items forming the kit is changed to “ReadyForReview” or “ReadyForAuction.” In step 820 the item status changes of step 818 are posted to the service provider inventory database where the kit may be reviewed by the E-Product Specialist or posted to the online auction provider web site as discussed above. Control then returns to step 728 of FIG. 7. Kits may also be developed prior to entering items into the database in the method shown for receiving items of FIGS. 2A-B and FIGS. 3A-B.

FIGS. 9A-B show a block flow diagram of the payment collection process of the present invention. Referring now to FIG. 9A, which is called from step 114 of FIG. 1, in step 908, for each of the items marked “sold”, shipping charges are calculated through an interface with the appropriate shipping vendor. The shipping charges that are determined at the auction site are estimated only and are a function of the auction process itself. Once the winner's information is collected, the inventory database will communicate with the winner's preferred shipper to determine actual cost. In most cases, the estimate and actual shipping cost will be the same.

The service provider inventory database may have an interface with shipping company computers, such as United Parcel Service and Federal Express, to automatically calculate shipping costs and acquire tracking numbers, which are stored in a tracking number field (inventory database field “sp tracking number”). Next, the service provider inventory database will determine if sales tax must be charged on the item, and if so, the sales tax is calculated (inventory database field “sp tax”). The taxable rate is determined by county and state.

The service provider inventory database will add the “oap win bid” field to the service provider inventory database “sp tax” field and the “oap ship charge” fields to a pre-determined handling charge to determine a total sale price for the item (inventory database field “sp total charge”). Once these fields have been calculated, the service provider inventory database marks the service provider payment status field indicating the record is ready for financial processing (inventory database field “sp payment status”).

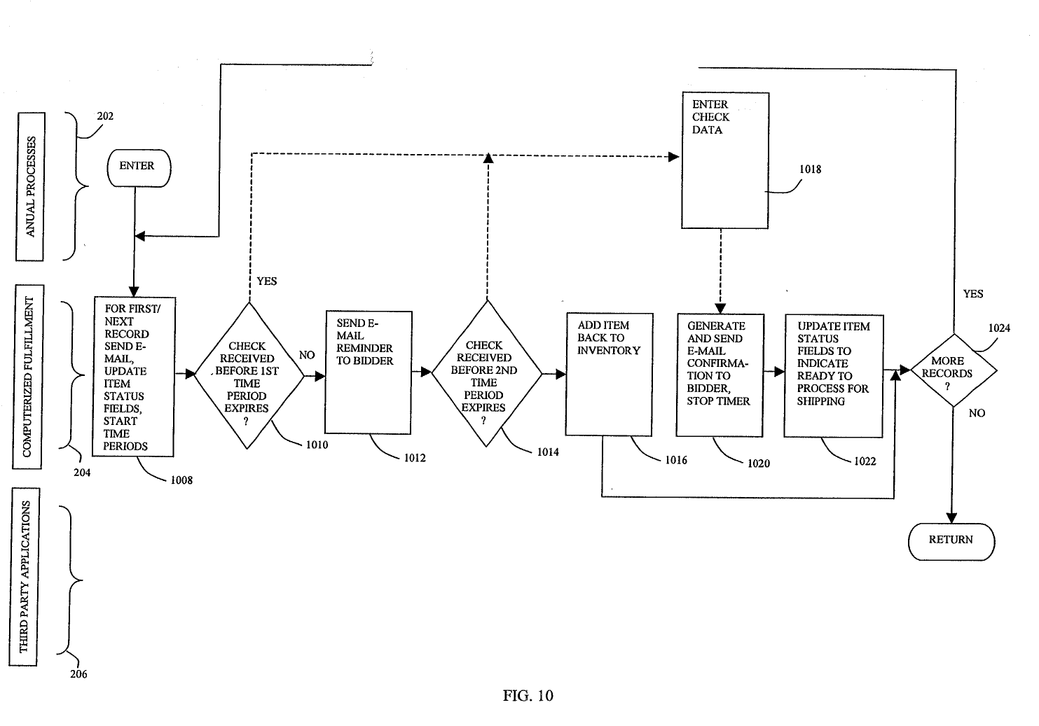

In step 910 each record is interrogated to determine the method of payment indicated by the winning auction bidder: credit card or certified check. Those records indicating payment by certified check are passed in step 912 to the certified check process of FIG. 10, which is described below.

A credit card process is used for the records indicating payment by credit card and are put into a batch file or are processed in real-time in step 914. Types of credit cards accepted by the online auction provider on behalf of the service provider include, but are not limited to, Visa, Master Card, American Express, and Discover. The credit card authorization number (inventory database field “sp cc authorization”) is entered into its respective record along with a credit card batch number (inventory database field “sp cc batch”) and date (inventory database field “sp pmt date”). This cc batch number is a batch number that a credit card processor recognizes, and is not a service provider batch number. The credit card processor considers all transactions in a day part of that day's batch. It is irrelevant if the cards are charged in real time. Each batch file is then sent to a credit card processor for approval.

In step 916 each credit card processor receiving a batch file processes the batch file. Each credit card processor returns the results of their processing to the service provider in step 918, where the results are posted to the service provider inventory database. In a preferred embodiment, there is only one credit card processor that processes all credit cards: American Express, MasterCard, Visa, and Discover. Records having credit card results are then processed in FIG. 9B.

Referring now to FIG. 9B, step 920 determines, for a first item record, if the credit card was valid and successfully charged. If the credit card was not valid and successfully charged, then in step 922 the appropriate notation is made in the “sp payment status” field of the item record. A field indicating further action is needed to complete the transaction is noted and used for reporting (inventory database field “sp financial action”). The service provider inventory database sends an e-mail to both the winning auction bidder and to the E-Product Specialist or manager indicating that the credit card was rejected. At this point the sale is “frozen” until in step 924 the E-Product Specialist or manager evaluates each item record marked for further action and determines its status and the next steps to be taken for the item. The winning auction bidder may be contacted, and a new credit card number obtained, or another method of payment may be agreed upon such as a wire transfer or certified check. Or, the auction can be considered null and void and the item will be returned to auction for a second time. Control then passes to step 932.

If step 920 determines that the credit card was successfully charged, then in step 926 the corresponding item record in the inventory database is updated with the information received from the credit card processor. In step 930 the item record is now marked ready to process for shipping (inventory database field “sp shipping key”). Step 932 determines if there are more item records with credit card information to be processed. If yes, control returns to step 920. If there are no more item records to process, then control returns to step 116 of FIG. 1.

FIG. 10 shows a block flow diagram of the certified check process of the present invention. Referring now to FIG. 10, in step 1008, which is called from step 912 of FIG. 9A, for a first item record, a text e-mail is generated indicating the total amount due and sent to the winning auction bidder. The service provider inventory database notes the issuance of this e-mail (inventory database field “sp check email”). The modification of the service provider check email field indicates the start of a first time period countdown (inventory database field “sp check follow”), and the start of a second time period countdown (inventory database field “sp check timer”) which is longer than the first time period.

Step 1010 determines if payment has been received before the first time period has expired. If payment has been received before the first time period has expired, the timer for the first time period is stopped and no further action based on the first time period is taken. Control then passes to step 1018. If step 1010 determines that no payment has been received before the first time period has expired, in step 1012 a follow-up e-mail is generated and sent to the winning auction bidder stating that if payment is not received by a certain date, the winning auction bidder will lose the rights to the item. Control then passes to step 1014.

Step 1014 determines if payment has been received before the second time period has expired. If payment has been received before the second time period has expired, the timer for the second time period is stopped and no further action based on the second time period is taken. Control then passes to step 1018. If step 1014 determines that no payment has been received before the second time period has expired, in step 1016 the item is added back to inventory by updating the database record (inventory database field “sp re-list”) and becomes available for auction again. Control then passes to step 1024.

In step 1018 the service provider inventory database is modified by a service provider staff member. The service provider staff member enters a deposit number indicating which bank deposit the check received was part of (inventory database field “sp check deposit), and the date the check was received (inventory database field “sp pmt date”). Utilizing the check deposit field for auditing purposes, all the records from a specified deposit number may be matched against a bank statement to verify financial integrity.

Once the service provider inventory database is modified in step 1018, in step 1020 a text e-mail confirmation may be generated and sent to the winning auction bidder indicating payment has been received (inventory database field “sp email confirmation”). The confirmation e-mail if sent may include, but is not limited to, the following:

Service Provider Corporate Information—Service provider name and customer support contact e-mail address;

Customer number for the winning auction bidder (inventory database field “sp customer number”);

A description of the item won (inventory database field “sp des two”);

Check number (inventory database field “sp check number”) created for security;

Payment method;

Amount of winning bid (inventory database field “oap win bid”);

Tax charged (inventory database field “sp tax”);

Shipping and handling charged (inventory database field “oap ship charge”);

Total charge (inventory database field “sp total charge”);

Item SKU number (inventory database field “SKU”);

Thank you message;

A note indicating the winning auction bidder needs to include the SKU number on all correspondence; and

A note indicating the winning auction bidder will be receiving an e-mail with shipping information. The note may also include information on related items. For example, for a bidder who has won a TV, a link may be included to a web site that sells universal TV remote controls that would be appropriate for the winner to purchase.

In step 1022 the service provider e-mail receipt field (inventory database field “sp email receipt”) will be modified indicating that the receipt was sent. The item record is now marked ready to process for shipping (inventory database field “sp shipping key”). Step 1024 determines if there are more item records with certified check information to be processed. If yes, control returns to step 1008. If there are no more item records to process, then control returns to step 116 of FIG. 1. One skilled in the art will recognize that other forms of payment, such as debit cards and e-wallets (not shown), would be compatible with the system and method of the present invention.

FIG. 11 shows a block flow diagram of the staging process of the present invention. Referring now to FIG. 11, which is called from step 116 of FIG. 1, in step 1108 the site personnel using the secure site client computer selects the items ready for shipping. In step 1110 the service provider inventory database generates a pick list of all the items selected by the site personnel. The pick list is ordered by pick location: aisle, section, shelf, and slot. In step 1112 the pick list is printed on the sheet printer at the secure site. If there have been any limitations entered on the shipment of an item, for example because of size, export restrictions, or hazardous material restrictions, those limitations or restrictions will appear on the pick list sheet.

In step 1114 the secure site personnel, utilizing the pick list, physically locates and retrieves the items on the pick list sheet and manually places a check mark on the pick list sheet as each item is located, noting any shipping limitations or restrictions pertaining to an item. When all items have been picked, the secure site personnel returns to the secure site client computer in step 1116 and marks those items that have been picked as indicated on the pick list sheet. The service provider inventory database retrieves shipping information for each picked item in step 1118. Tracking numbers are obtained through an electronic interface with the shipper, such as United Parcel Service or Federal Express in step 1120. If the item is sent via the United States Postal Service or via a common carrier that does not provide tracking numbers, the “sp tracking number” indicates the ship method as opposed to a tracking number. In step 1122 a shipping label for each item is printed on the secure site label printer, and a packing slip for each item is printed on the sheet printer. The SKU number of the item is included on the label.

At this time, in step 1124, the item status is updated in the service provider inventory database to “staged.” Finally, in step 1126, the secure site personnel box or package the items, responding appropriately to any shipping restrictions or limitations for a particular item. The secure site personnel apply the shipping label, and insert the packing list in a clear plastic sticky bag, which is also affixed to the box or packaging. Control then returns to step 118 of FIG. 1.

FIG. 12 shows a block flow diagram of the shipping process of the present invention. Referring now to FIG. 12, which is called from step 118 of FIG. 1, in step 1208 the secure site personnel scan the SKUs of boxed items ready for shipping. This data is then uploaded to the service provider inventory database.

Upon receiving the uploaded SKU data, in step 1210 the service provider inventory database builds a shipping manifest and interfaces with the shipping company computer. In step 1212 the shipping company sends a confirmation of receipt of the shipping manifest. In step 1214 the service provider inventory database updates the records for the to be shipped items with a ship date (inventory database field “ss ship date”).

Then in step 1216 the financial information is posted to the service provider accounting system. A receipt is also generated and sent via text e-mail to the winning auction bidder. The service provider e-mail receipt field (inventory database field “sp email receipt”) will be modified indicating that the receipt was sent. The e-mail receipt may include, but is not limited to, the following:

Service Provider Corporate Information—Service provider name and customer support contact e-mail address;

Customer number for the winning auction bidder (inventory database field “sp customer number”);

A description of the item won (inventory database field “sp des two”);

Partial credit card number if applicable (inventory database field “sp cc partial”);

Credit card type if applicable (inventory database field “oap card”);

Amount of winning bid (inventory database field “oap win bid”);

Tax charged (inventory database field “sp tax”);

Shipping and handling charged (inventory database field “oap ship charge”);

Total charge (inventory database field “sp total charge”);

Item SKU number (inventory database field “SKU”);

Thank you message; and

A note indicating the winning auction bidder will receive an e-mail with shipping information. The note may also include information on related items. For example, for a bidder who has won a TV, a link may be included to a web site that sells universal TV remote controls that would be appropriate for the winner to purchase.

In step 1218 the accounting system processes the posted financial information. In step 1220 the service provider inventory database generates and sends an e-mail receipt to each of the winning auction bidders with the shipping information for their purchased items. This e-mail receipt may include, but is not limited to, the following:

Service Provider Corporate Information—Service provider name and customer support contact e-mail address;

A description of the item won (inventory database field “sp des two”);

Customer number (inventory database field “sp customer number”);

Item SKU number (inventory database field “SKU”);

Ship date (inventory database field “ss ship date”);

Ship method (inventory database field “oap ship method”); and

Thank you message. Information may also be included on related items. For example, for a bidder who has won a TV, a link may be included to a web site that sells universal TV remote controls that would be appropriate for the winner to purchase.

In step 1222 the shipping manifest is printed on the sheet printer at the secure site. In step 1224 the site personnel places the shipping manifest with the boxes on the loading dock to be picked up by the shipping company. Control then returns to step 120 of FIG. 1. A Returned Merchandise Authorization procedure is used should the need arise for the winning auction bidder to return an item purchased.

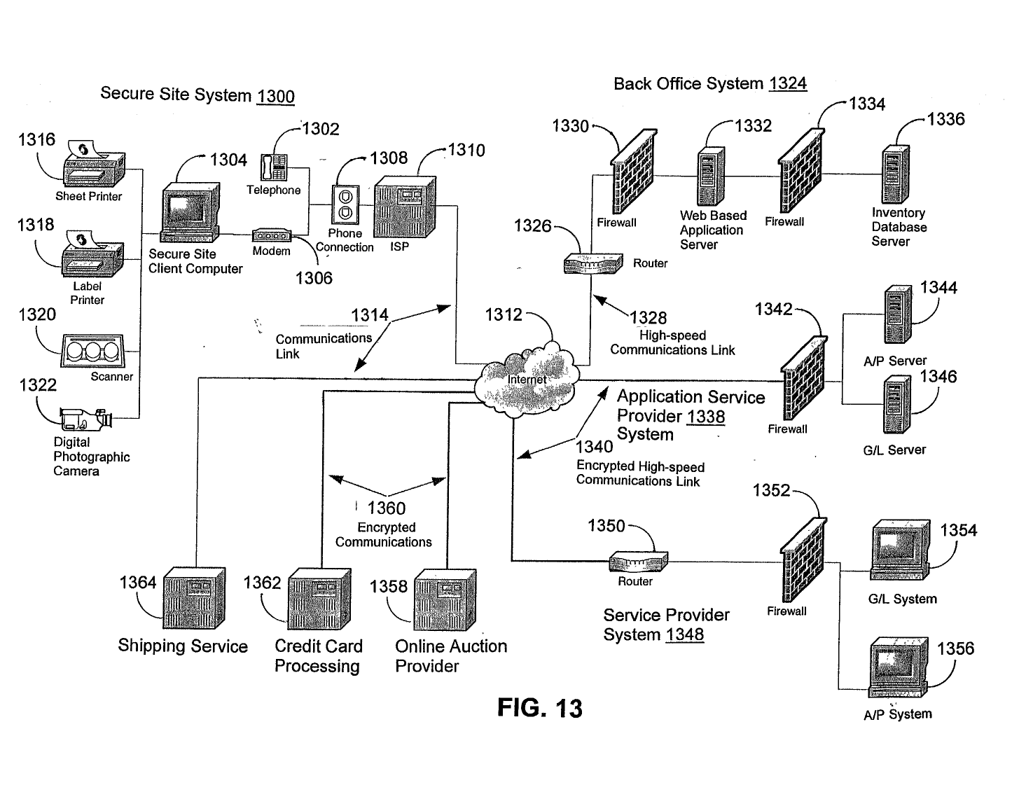

FIG. 13 shows an embodiment of the system of internet auctioning of goods seized or recovered by local, county, state, or federal law enforcement and other government agencies of the present invention. Referring now to FIG. 13, the system of internet auctioning of seized property of the present invention in a preferred embodiment is a web-based solution. A Secure Site System 1300 accesses the functionality of the system through a web site hosted by Back Office System 1324. Only one Secure Site System 1300 is shown in FIG. 13 for simplicity, but one skilled in the art will recognize that many more could be shown. The present invention envisions multiple Secure Site Systems 1300 situated in various geographic locations accessing the interface of Back Office System 1324. Each Secure Site System 1300 may be located in different cities and counties of different states across the country and locations around the world.

Secure Site Client Computer 1304 is connected via Modem 1306 and Phone Connection 1308 to an Internet Service Provider 1310, which in turn gives Secure Site Client Computer 1304 access to the Internet 1312 via Communications Link 1314. Modem 1306, which typically provides 56K modem access, may be an external modem as shown, or an internal modem within Secure Site Client Computer 1304. Communications Link 1314 may be standard telephone line, a T-1 line or higher, a DS-1 line or higher, cable Internet access, or any other suitable communications link. Telephone 1302 is also connected to Phone Connection 1308 and Modem 1306.

Sheet Printer 1316, which is connected to Secure Site Client Computer 1304, may be used to print out put-away forms, pick lists, packing slips, and shipping manifests. Label Printer 1318, also connected to Secure Site Client Computer 1304, may be used to print out SKU bar code labels and shipping labels. Scanner 1320 may be used to scan bar code labels that may represent the case ID used by the law enforcement agency. The law enforcement agency may have attached the bar code label to the item, and Scanner 1320 may be used to scan the SKU bar code number into an SKU field for data entry. In the preferred embodiment, Scanner 1320 is connected to Secure Site Client Computer 1304 through a Universal Serial Bus (USB). Digital Photographic Camera 1322 is used to photograph the seized items to be auctioned, and in the preferred embodiment is also connected to Secure Site Client Computer 1304 through a USB.

The web site accessed by Secure Site Client Computer 1304 is provided by Back Office System 1324. In a preferred embodiment of the invention, Back Office System 1324 is provided by HighJump Software, Inc. Back Office System 1324 provides the web site and the inventory database accessed by each of the Secure Site Systems 1300. Router 1326 handles the traffic from the various Secure Site Systems 1300 over High Speed Communications Link 1328, which is typically a T1 line at 8,000 k or higher. Firewall 1330 provides security for Web Based Application Server 1332. Firewall 1334 provides security for Inventory Database Server 1336, which houses the inventory database and the registration database.

In a preferred embodiment, Application Service Provider System 1338 provides the accounting functions necessary for the system of internet auctioning of seized property of the present invention. One such application service provider of accounting packages for client/server environments is PeopleSoft, Inc. Encrypted High-Speed Communications Link 1340, which is typically DSL, connects Application Service Provider System 1338 through the Internet 1312 to Service Provider System 1348. Firewall 1342 provides security for A/P Server 1344 and G/L Server 1346.

Service Provider System 1348 provides management functions for the system of the present invention. Router 1350 handles the traffic from Application Service Provider System 1338, Back Office System 1324, and from other sources over Encrypted High-Speed Communications Link 1340. Firewall 1352 provides security for G/L System 1354 and A/P System 1356.

Online Auction Provider 1358 utilizes Encrypted Communications Link 1360 to send and receive information over the Internet. Online Auction Provider 1358 receives information on items to be auctioned from Back Office System 1324. Online Auction Provider 1358 auctions the items online and sends the auction results to Back Office System 1324. One such online auction provider is FairMarket.

Credit Card Processor 1362 also utilizes Encrypted Communications Link 1360. Credit Card Processor 1362 receives batch files or files in real-time from Back Office System 1324 containing credit card data. Credit Card Processor 1362 processes the credit card data, and returns the results to Back Office System 1324. Bank of America is one entity that may provide credit card processing.

Shipping Service 1364 sends and receives information over Communications Link 1314 to Back Office System 1324. The service provider inventory database may receive tracking numbers from Shipping Service 1364. The service provider inventory database sends a shipping manifest to Shipping Service 1364. Shipping Service 1364 may be a common carrier such as Federal Express or United Parcel Service.

Having described a presently preferred embodiment of the present invention, it will be understood by those skilled in the art that many changes in construction and circuitry and widely differing embodiments and applications of the invention will suggest themselves without departing from the scope of the present invention, as defined in the claims. The disclosures and the description herein are intended to be illustrative and are not in any sense limiting of the invention, defined in scope by the following claims.

What is claimed is:

1. A method for auctioning goods seized or recovered by at least one government agency, the method comprising:
(a) receiving by a service provider at least one good from the at least one government agency;
(b) entering data regarding said at least one good into an inventory database, wherein a database record is created for said at least one good;
(c) posting said database record for said at least one good to an online auction provider web site;
(d) receiving auction data from said online auction provider web site from an online auction for said at least one good auctioned to at least one winning auction bidder;
(e) determining a payment method from said auction data for said at least one good auctioned;
(f) implementing a process according to said payment method to collect payment from said at least one winning auction bidder; and
(g) shipping said at least one good auctioned to said at least one winning auction bidder.

2. A method according to claim 1 further comprising:
entering by said service provider into a contractual relationship with the at least one government agency to be an exclusive agent for auctions over the Internet of said at least one good for the at least one government agency.

3. A method according to claim 1 further comprising:
establishing by said service provider at least one secure site for said receiving of said at least one good from the at least one government agency.

4. A method according to claim 1 further comprising:
attaching a bar code label to said at least one good;
taking a digital photograph of said at least one good;
entering a bar code number from said bar code label into a memory of a secure site client computer;
storing a digital image from said digital photograph in said memory of said secure site client computer;
storing a plurality of other information about said at least one good in said memory of said secure site client computer; and
transmitting a batch file containing said bar code number, said digital image, and said plurality of other information about said at least one good from said secure site client computer to an inventory database server, wherein said bar code number, said digital image, and said plurality of other information about said at least one good in said batch file are a portion of said data regarding said at least one good entered into said inventory database stored in said inventory database server.

5. A method according to claim 4 further comprising:
maintaining a registration database containing a plurality of records, wherein each record contains information about a stolen good and an owner of said stolen good;
comparing said batch file containing information about said at least one good to said registration database; and
when a match is found between a one of said plurality of records about said stolen goods and said at least one good, indicating that said stolen good and said at least one good are one o and the same, returning said at least one good to said owner.

6. A method according to claim 1 further comprising:
taking a digital photograph of said at least one good;
storing a digital image from said digital photograph in a memory of a secure site client computer;
entering a plurality of information about said at least one good into said memory of said secure site client computer;
transmitting said plurality of information and said digital image from said secure site client computer to an inventory database server;
updating said inventory database server with said plurality of information and said digital image of said at least one good;
issuing a bar code number for said at least one good;
printing a bar code label containing said bar code number; and
attaching said bar code label to said at least one good.

7. A method according to claim 6 further comprising:
maintaining a registration database containing a plurality of records, wherein each record contains information about a stolen good and an owner of said stolen good;
comparing said plurality of information and said digital image to each of said plurality of records in said registration database; and
when a match is found between a one of said plurality of records about said stolen goods and said at least one good, indicating that said stolen good and said at least one good are one and the same, returning said at least one good to said owner.

8. A method according to claim 1 further comprising:
prior to said posting step (c), adding at least one description to said database record for said at least one good.

9. A method according to claim 1 wherein said auction data is received from said online auction provider web site in a tab-delimited file.

10. A method according to claim 1 wherein said auction data is received from said online auction provider web site in real time through an XML interface at the close of said online auction.

11. A method according to claim 1 wherein said auction data is comprised of at least one of a registration information, a billing information, and an other information.

12. A method according to claim 1 further comprising:
posting said auction data to said inventory database; and
updating a status field for said database record for said at least one good to a one of sold and unsold.

13. A method according to claim 1 further comprising:
creating at least one kit, said creating at least one kit comprising,
combining at least two goods received from the at least one government agency to form said at least one kit, wherein said at least two goods of said at least one kit form a logical selling unit;
entering kit data regarding said at least one kit in said inventory database, wherein a kit database record is created for said at least one kit; and
posting said kit database record for said at least one kit to said online auction provider web site for online auction.

14. A method according to claim 1 wherein said payment method is by credit card and said process is a credit card process, said credit card process comprising:
storing in a batch file a credit card authorization number and a credit card batch number for said at least one good auctioned to said at least one winning auction bidder;
transmitting said batch file to a credit card processor for processing;
posting to said inventory database the results of said processing received from said credit card processor;
when said results of said processing by said credit card processor indicate that a credit card was successfully charged, updating said database record for said at least one good with said results of said processing; and
updating said database record for said at least one good indicating that said at least one good is ready for shipping.

15. A method according to claim 14 wherein said storing and said transmitting steps are replaced with the following new step:
transmitting in real time to said credit card processor for processing said credit card authorization number and said credit card batch number for said at least one good auctioned to said at least one winning auction bidder.

16. A method according to claim 1 wherein said payment method is by certified check and said process is a certified check process, said certified check process comprising:
generating a first e-mail indicating a total amount due;
sending said first e-mail to said at least one winning auction bidder;
updating said database record for said at least one good in said inventory database with said issuance of said e-mail;
starting a first time period countdown and a second time period countdown, wherein said second time period countdown is longer than said first time period countdown;
when said service provider has received a certified check from said at least one winning bidder for said at least one good before said first time period has expired, updating said database record for said at least one good with data relating to said certified check;
when said service provider has not received said certified check from said at least one winning bidder for said at least one good before said first time period has expired, generating a second e-mail indicating a total amount due;
sending said second e-mail to said at least one winning auction bidder, wherein said second e-mail indicates to said at least one winning bidder a predetermined date by which said certified check must be received;
when said service provider has received said certified check from said at least one winning bidder for said at least one good before said second time period has expired, updating said database record for said at least one good with data relating to said certified check; and
when said service provider has not received said certified check from said at least one winning bidder for said at least one good before said second time period has expired, updating said database record for said at least one good indicating that said at least one good is available for auction.

17. A method according to claim 1 further comprising:
implementing a staging process before said shipping step, said staging process comprising:
retrieving shipping information from said inventory database for said at least one good auctioned to said at least one winning bidder;
printing a shipping label from said shipping information for said at least one good;
updating said database record for said at least one good indicating that said at least one good is staged;
packaging said at least one good in a package; and
attaching said shipping label to said package containing said at least one good.

18. A method according to claim 1 wherein said shipping step further comprises:
scanning said shipping label for a SKU number;
uploading said SKU number to said inventory database;
building a shipping manifest;
updating said database record for said at least one good with a ship date; and
printing said shipping manifest and placing said shipping manifest with said package containing said at least one good for pick up by a shipping company.

19. A method for auctioning goods seized or recovered by at least one government agency, the method comprising:
(a) receiving by a service provider a plurality of goods from the at least one government agency;
(b) entering data regarding said plurality of goods into an inventory database, wherein a database record is created for each of said plurality of goods;
(c) posting each of said database records for said each of said plurality of goods to an online auction provider web site;
(d) receiving auction data from said online auction provider web site from an online auction for at least one good from said plurality of goods auctioned to at least one winning auction bidder;
(e) determining a payment method from said auction data for said at least one good auctioned;
(f) implementing a process according to said payment method to collect payment from said at least one winning auction bidder; and
(g) shipping said at least one good auctioned to said at least one winning auction bidder.

20. A method according to claim 19 further comprising:
entering by said service provider into a contractual relationship with the at least one government agency to be an exclusive agent for auctions over the Internet of said plurality of goods for the at least one government agency.

21. A method according to claim 19 further comprising:
establishing by said service provider at least one secure site for said receiving of said plurality of goods from the at least one government agency.

22. A method according to claim 19 further comprising:
attaching a bar code label to each of said plurality of goods;
taking a digital photograph of each of said plurality of goods;
entering a bar code number from each of said bar code labels into a memory of a secure site client computer;
storing a digital image from each of said digital photographs in said memory of said secure site client computer;
storing a plurality of other information about each of said plurality of goods in said memory of said secure site client computer; and
transmitting a batch file containing each of said bar code numbers, each of said digital images, and each of said plurality of other information about each of said plurality of goods from said secure site client computer to an inventory database server, wherein each of said bar code numbers, each of said digital images, and each of said plurality of other information about each of said plurality of goods in said batch file are a portion of said data regarding each of said plurality of goods entered into said inventory database stored in said inventory database server.

23. A method according to claim 22 further comprising:
maintaining a registration database containing a plurality of records, wherein each record contains information about a stolen good and an owner of said stolen good;
comparing said batch file containing information about each of said plurality of goods to said registration database; and
when a match is found between a one of said plurality of records about said stolen goods and one of said plurality of goods, indicating that a one of said stolen goods and said one of said plurality of goods are one and the same, returning said one of said plurality of goods to said owner.

24. A method according to claim 19 further comprising:
taking a digital photograph of each of said plurality of goods;
storing a digital image from each of said digital photographs in a memory of a secure site client computer;
entering a plurality of information about said plurality of goods into said memory of said secure site client computer;
transmitting each of said plurality of information and each of said digital images from said secure site client computer to an inventory database server;
updating said inventory database server with each of said plurality of information and each of said digital images of each of said plurality of goods;
issuing a bar code number for each of said plurality of goods;
printing a bar code label containing each of said bar code numbers; and
attaching each of said bar code labels to each of said plurality of goods.

25. A method according to claim 24 further comprising:
maintaining a registration database containing a plurality of records, wherein each record contains information about a stolen good and an owner of said stolen good;
comparing each of said plurality of information and each of said digital images to each of said plurality of records in said registration database; and
when a match is found between a one of said plurality of records about said stolen goods and a one of said plurality of goods, indicating that said stolen good and said one of said plurality of goods are one and the same, returning said one of said plurality of goods to said owner.

26. A method according to claim 19 further comprising:
prior to said posting step (c), adding at least one description to each of said database records for said plurality of goods.

27. A method according to claim 19 wherein said auction data is received from said online auction provider web site in a tab-delimited file.

28. A method according to claim 19 wherein said auction data is received from said online auction provider web site in real time through an XML interface at the close of said online auction.

29. A method according to claim 19 wherein said auction data is comprised of at least one of a registration information, a billing information, and an other information.

30. A method according to claim 19 further comprising:
posting said auction data to said inventory database; and
updating a status field for each of said database records for said plurality of goods to a one of sold and unsold.

31. A method according to claim 19 further comprising:
creating at least one kit, said creating at least one kit comprising,
combining at least two goods received from the at least one government agency to form said at least one kit, wherein said at least two goods of said at least one kit form a logical selling unit;
entering kit data regarding said at least one kit in said inventory database, wherein a kit database record is created for said at least one kit; and
posting said kit database record for said at least one kit to said online auction provider web site for online auction.

32. A method according to claim 19 wherein said payment method is by credit card and said process is a credit card process, said credit card process comprising:
storing in a batch file a credit card authorization number and a credit card batch number for each of said plurality of goods auctioned to said at least one winning auction bidder;
transmitting said batch file to a credit card processor for processing;
posting to said inventory database the results of said processing received from said credit card processor;
when said results of said processing by said credit card processor indicate that a credit card was successfully charged, updating said database record for each of said plurality of goods with said results of said processing; and
updating said database record for each of said plurality of goods indicating that each of said plurality of goods is ready for shipping.

33. A method according to claim 32 wherein said storing and said transmitting steps are replaced with the following new step:
transmitting in real time to said credit card processor for processing said credit card authorization number and said credit card batch number for each of said plurality of goods auctioned to said at least one winning auction bidder.

34. A method according to claim 19 wherein said payment method is by certified check and said process is a certified check process, said certified check process comprising:
generating a first e-mail indicating a total amount due;
sending said first e-mail to said at least one winning auction bidder;
updating each of said database records for each of said plurality of goods in said inventory database with said issuance of said e-mail;
starting a first time period countdown and a second time period countdown, wherein said second time period countdown is longer than said firs t time period countdown;
when said service provider has received a certified check from said at least one winning bidder for each of said plurality of goods before said first time period has expired, updating said database record for each of said plurality of goods with data relating to said certified check;
when said service provider has not received said certified check from said at least one winning bidder for each of said plurality of goods before said first time period has expired, generating a second e-mail indicating a total amount due;
sending said second e-mail to said at least one winning auction bidder, wherein said second e-mail indicates to said at least one winning bidder a predetermined date by which said certified check must be received;
when said service provider has received said certified check from said at least one winning bidder for each of said plurality of goods before said second time period has expired, updating said database record for each of said plurality of goods with data relating to said certified check; and
when said service provider has not received said certified check from said at least one winning bidder for each of said plurality of goods before said second time period has expired, updating said database record for each of said plurality of goods indicating that each of said plurality of goods are available for auction.

35. A method according to claim 19 further comprising:
implementing a staging process before said shipping step, said staging process comprising:
retrieving shipping information from said inventory database for each of said plurality of goods auctioned to said at least one winning bidder;
printing a shipping label from said shipping information for each of said plurality of goods;
updating said database record for each of said plurality of goods indicating that each of said plurality of goods is staged;
packaging each of said plurality of goods in a package; and
attaching said shipping label to said package containing each of said plurality of goods.

36. A method according to claim 19 wherein said shipping step further comprises:
scanning each of said shipping labels for a SKU number;
uploading each of said SKU numbers to said inventory database;
building a shipping manifest;
updating each of said database records for each of said plurality of goods with a ship date; and
printing said shipping manifest and placing said shipping manifest with each of said packages containing each of said plurality of goods for pick up by a shipping company.

37. A system for auctioning goods seized or recovered by at least one government agency, the system comprising:
a web based application server computer having an interface for communicating over a computer network;
a secure site client computer located at a secure site that accesses said interface over said computer network;
an inventory database in communication with said web based application server computer and said secure site client computer;
said secure site client computer enabled to capture data for a plurality of goods received from the at least one government agency and transmitting said captured data over said computer network to said inventory database;
said inventory database enabled to create and store a plurality of records from said captured data corresponding to said plurality of goods; and
said web based application server computer enabled to post said plurality of records for said plurality of goods stored in said inventory database to an online auction provider web site, and to process auction data received from said online auction provider web site from an online auction for at least one good from said plurality of goods auctioned to at least one winning auction bidder.

38. The system according to claim 37 wherein said computer network is the Internet.

39. The system according to claim 37 further comprising:
a plurality of secure site client computers located at a plurality of secure sites that access said interface over said computer network.

40. The system according to claim 37 further comprising:
an inventory database server for storing said inventory database, wherein said inventory database server is in communication with said web based application server computer and said secure site client computer.

41. The system according to claim 37 further comprising:
a sheet printer connected to said secure site client computer for printing put-away forms, pick lists, packing slips, and shipping manifests;
a label printer connected to said secure site client computer for printing bar code labels and shipping labels;
a scanner connected to said secure site client computer for scanning bar code labels and for scanning SKU bar code numbers into SKU fields; and
a digital photographic camera connected to said secure site client computer for photographing said plurality of goods received from the at least one government agency and for sending digital images of said plurality of goods to said secure site client computer.

42. The system according to claim 37 further comprising:
an application service provider system in communication with said web based application server computer for providing accounting functions to the system for auctioning goods seized or recovered by the at least one government agency; and
a service provider system in communication with said web based application server computer for providing management functions to the system for auctioning goods seized or recovered by the at least one government agency.

43. The system according to claim 42 further comprising:
an encrypted high speed communications link for sending data between said application service provider system and said service provider system via said computer network.

44. The system according to claim 37 further comprising:
a first encrypted communication link for sending data between said web based application server computer and a credit card processor via said computer network.

45. The system according to claim 37 further comprising:
a second encrypted communication link for sending data between said web based application server computer and said online auction provider web site via said computer network.
